(19) United States
(12) Patent Application Publication
(10) Pub. No.: US 2026/0166878 A1
(43) Pub. Date: Jun. 18, 2026

(54) LIQUID EJECTION SUBSTRATE, LIQUID EJECTION HEAD, AND RECORDING APPARATUS

(71) Applicant: CANON KABUSHIKI KAISHA, Tokyo (JP)

(72) Inventors: ATSUSHI HIRAMOTO, Tokyo (JP); YUKI KOMORI, Tokyo (JP); MASAFUMI MORISUE, Tokyo (JP)

(21) Appl. No.: 19/412,004

(22) Filed: Dec. 8, 2025

(30) Foreign Application Priority Data
Dec. 12, 2024 (JP) 2024-218131

(51) Int. Cl. B41J 2/14; B41J 2/175; B41J 2/19

(52) U.S. Cl. CPC B41J 2/1433; B41J 2/17563; B41J 2/19; B41J 2002/14419

(57) ABSTRACT

A liquid ejection substrate includes an internal liquid flow path formed by nozzles, individual channels communicating with the nozzles, and a common liquid chamber communicating with the individual channels. The liquid ejection substrate includes: a nozzle-forming member having a liquid ejection surface on which the nozzles open; a first channel substrate including a first surface on which the nozzle forming member is provided, a second surface on the opposite side from the first surface, and a first wall portion forming a wall portion of the individual channels and the common liquid chamber; and a second channel substrate including a third surface joined to the second surface, and a second wall portion forming a wall portion of the common liquid chamber. The second wall portion includes a part where a cross section perpendicular to a first direction has a different sectional area from that of the first wall portion.

### BACKGROUND

### Field of the Technology

The present disclosure relates to a liquid ejection substrate and a fabrication method thereof, a liquid ejection head including the liquid ejection substrate, and a recording apparatus including the liquid ejection head.

### Description of the Related Art

Liquid flow paths formed inside the liquid ejection substrate of a liquid ejection head used for inkjet printing are formed by liquid-ejecting nozzles, individual supply ports for supplying liquid to the nozzles, and common liquid chambers or the like for supplying liquid to the individual supply ports. Japanese Patent Application Publication No. 2023-1621 discloses a configuration in which a common liquid chamber is formed inside a single substrate.

The common liquid chamber in such a liquid ejection head may need to be configured in a more intricate shape due to some requirements. For example, it is preferable for the common liquid chamber to have a large volume from the perspectives of improving the efficiency of replenishing liquid to the nozzles, and of preventing crosstalk between adjacent nozzles. The design of the common liquid chamber may cause air bubble accumulation or adhesion of solutes due to stagnation in the liquid flow.

Dry etching and wet etching are commonly used for forming common liquid chambers. However, these fabrication methods offer a low degree of freedom in design. These methods only allow formation of simple-shaped chambers. It is difficult to form a common liquid chamber that can improve the performance of the liquid ejection head with these methods.

### SUMMARY

An object of the present disclosure is to provide a liquid ejection substrate having a common liquid chamber configured for better performance.

To achieve the object set forth above, the present disclosure provides a liquid ejection substrate
for use in a liquid ejection head, having an internal liquid flow path including a nozzle, an individual channel communicating with the nozzle, and a common liquid chamber communicating with the individual channel, the liquid ejection substrate including:
a nozzle forming member having a liquid ejection surface on which the nozzle opens;
a first channel substrate including a first surface on which the nozzle forming member is provided, a second surface on an opposite side from the first surface, and a first wall portion forming a wall portion of the individual channel and the common liquid chamber;
a second channel substrate including a third surface that is joined to the second surface of the first channel substrate in a first direction and a second wall portion forming a wall portion of the common liquid chamber,
wherein
the second wall portion includes a part where a cross section perpendicular to the first direction has a different sectional area from a sectional area of the first wall portion.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic plan view of the liquid ejection surface of a liquid ejection substrate according to a comparative example as viewed in the Z direction.

FIG. 1B is a schematic cross-sectional view of a cross section A-A perpendicular to the Y direction of FIG. 1A.

FIG. 1C is a schematic cross-sectional view of a cross section B-B perpendicular to the X direction of FIG. 1A.

FIG. 2A is a schematic plan view of the liquid ejection surface of a liquid ejection substrate according to a first embodiment as viewed in the Z direction.

FIG. 2B is a schematic cross-sectional view of a cross section A-A perpendicular to the Y direction of FIG. 2A.

FIG. 2C is a schematic cross-sectional view of a cross section B-B perpendicular to the X direction of FIG. 2A.

FIG. 3A is a schematic plan view of the liquid ejection surface of the liquid ejection substrate according to a second embodiment as viewed in the Z direction.

FIG. 3B is a schematic cross-sectional view of a cross section A-A perpendicular to the Y direction of FIG. 3A.

FIG. 3C is a schematic cross-sectional view of a cross section B-B perpendicular to the X direction of FIG. 3A.

FIG. 4A is a schematic plan view of the liquid ejection surface of the liquid ejection substrate according to a third embodiment as viewed in the Z direction.

FIG. 4B is a schematic cross-sectional view of a cross section A-A perpendicular to the Y direction of FIG. 4A.

FIG. 4C is a schematic cross-sectional view of a cross section B-B perpendicular to the X direction of FIG. 4A.

FIG. 5A is a schematic plan view of the liquid ejection surface of the liquid ejection substrate according to a fourth embodiment as viewed in the Z direction.

FIG. 5B is a schematic cross-sectional view of a cross section A-A perpendicular to the Y direction of FIG. 5A.

FIG. 5C is a schematic cross-sectional view of a cross section B-B perpendicular to the X direction of FIG. 5A.

FIG. 6A is a schematic plan view of the liquid ejection surface of the liquid ejection substrate according to a fifth embodiment as viewed in the Z direction.

FIG. 6B is a schematic cross-sectional view of a cross section A-A perpendicular to the Y direction of FIG. 6A.

FIG. 6C is a schematic cross-sectional view of a cross section B-B perpendicular to the X direction of FIG. 6A.

FIG. 7A is a schematic plan view of the liquid ejection surface of a liquid ejection substrate according to a sixth embodiment as viewed in the Z direction.

FIG. 7B is a schematic cross-sectional view of a cross section A-A perpendicular to the Y direction of FIG. 7A.

FIG. 7C is a schematic cross-sectional view of a cross section B-B perpendicular to the X direction of FIG. 7A.

FIG. 8A is a schematic plan view of the liquid ejection surface of a liquid ejection substrate according to a seventh embodiment as viewed in the Z direction.

FIG. 8B is a schematic cross-sectional view of a cross section A-A perpendicular to the Y direction of FIG. 8A.

FIG. 8C is a schematic cross-sectional view of a cross section B-B perpendicular to the X direction of FIG. 8A.

FIG. 9A is a schematic plan view of the liquid ejection surface of a liquid ejection substrate according to an eighth embodiment as viewed in the Z direction.

FIG. 9B is a schematic cross-sectional view of a cross section A-A perpendicular to the Y direction of FIG. 9A.

FIG. 9C is a schematic cross-sectional view of a cross section B-B perpendicular to the X direction of FIG. 9A.

FIG. 10A is a schematic plan view of the liquid ejection surface of a liquid ejection substrate according to a ninth embodiment as viewed in the Z direction.

FIG. 10B is a schematic cross-sectional view of a cross section A-A perpendicular to the Y direction of FIG. 10A.

FIG. 10C is a schematic cross-sectional view of a cross section B-B perpendicular to the X direction of FIG. 10A.

FIG. 11A is a schematic plan view of the liquid ejection surface of a liquid ejection substrate according to a tenth embodiment as viewed in the Z direction.

FIG. 11B is a schematic cross-sectional view of a cross section A-A perpendicular to the Y direction of FIG. 11A.

FIG. 11C is a schematic cross-sectional view of a cross section B-B perpendicular to the X direction of FIG. 11A.

FIG. 12A is a schematic plan view of the liquid ejection surface of a liquid ejection substrate according to an eleventh embodiment as viewed in the Z direction.

FIG. 12B is a schematic cross-sectional view of a cross section A-A perpendicular to the Y direction of FIG. 12A.

FIG. 12C is a schematic cross-sectional view of a cross section B-B perpendicular to the X direction of FIG. 12A.

FIG. 13 is an illustrative diagram explaining the relationship between a directional displacement and an opening width.

FIG. 14A is a plan view of a first configuration example of a second channel substrate according to an eleventh embodiment as viewed from a fourth surface side.

FIG. 14B is a schematic cross-sectional view of a cross section A-A perpendicular to the Y direction of FIG. 14A.

FIG. 14C is a plan view of a second configuration example of the second channel substrate according to the eleventh embodiment as viewed from the fourth surface side.

FIG. 14D is a schematic cross-sectional view of a cross section A-A perpendicular to the Y direction of FIG. 14C.

FIG. 15A is a schematic plan view of the liquid ejection surface of a liquid ejection substrate according to a twelfth embodiment as viewed in the Z direction.

FIG. 15B is a schematic cross-sectional view of a cross section A-A perpendicular to the Y direction of FIG. 15A.

FIG. 15C is a schematic cross-sectional view of a cross section B-B perpendicular to the X direction of FIG. 15A.

FIG. 16 is an illustrative diagram of a first common liquid chamber and a second common liquid chamber according to the twelfth embodiment.

FIG. 17A is a schematic plan view of the liquid ejection surface of a liquid ejection substrate according to a thirteenth embodiment as viewed in the Z direction.

FIG. 17B is a schematic cross-sectional view of a cross section A-A perpendicular to the Y direction of FIG. 17A.

FIG. 17C is a schematic cross-sectional view of a cross section B-B perpendicular to the X direction of FIG. 17A.

FIG. 18A is a schematic plan view of the liquid ejection surface of a liquid ejection substrate according to a fourteenth embodiment as viewed in the Z direction.

FIG. 18B is a schematic cross-sectional view of a cross section A-A perpendicular to the Y direction of FIG. 18A.

FIG. 18C is a schematic cross-sectional view of a cross section B-B perpendicular to the X direction of FIG. 18A.

FIG. 19A is a schematic cross-sectional view of a liquid ejection substrate according to Example 1 as viewed in a cross section perpendicular to the Y direction.

FIG. 19B is a schematic cross-sectional view of the liquid ejection substrate as viewed in a cross section perpendicular to the X direction.

FIG. 19C is a schematic cross-sectional view of the liquid ejection substrate as viewed in cross sections shown in FIG. 19A.

FIG. 20 is an illustrative diagram of a fabrication method of the liquid ejection substrate according to Example 1.

FIG. 21 is an illustrative diagram of a fabrication method of the liquid ejection substrate according to Example 2.

FIG. 22 is an illustrative diagram of a fabrication method of the liquid ejection substrate according to Example 3.

FIG. 23 is a diagram illustrating a schematic configuration of a recording apparatus equipped with a liquid ejection head.

### DESCRIPTION OF THE EMBODIMENTS

Features of the present disclosure will become apparent from the following description of embodiments with reference to the attached drawings. The following description of embodiments is described by way of example.

### Liquid Ejection Head and Recording Apparatus

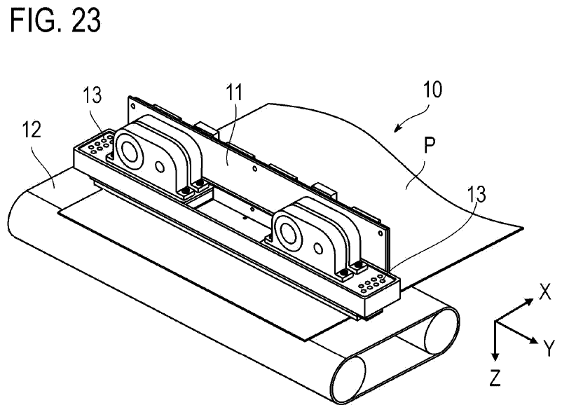

A liquid ejection head and a recording apparatus equipped with the liquid ejection head, according to the present disclosure, will be described. FIG. 23 is a diagram illustrating a schematic configuration of a liquid ejection apparatus equipped with a liquid ejection head 11, more particularly an inkjet recording apparatus (hereinafter referred to as a recording apparatus) 10 that performs recording by ejecting ink as an example of liquid. The recording apparatus 10 includes a line-type (page wide) liquid ejection head 11 and a conveying portion 12 that conveys recording medium P. The liquid ejection head 11 includes a liquid ejection substrate, which is disposed so that its longitudinal direction is substantially perpendicular to the conveying direction of the recording medium P and which has liquid flow paths formed therein, and a housing that supports the liquid ejection substrate. The recording apparatus 10 performs continuous recording in single pass while conveying plural sheets of recording medium P continuously or intermittently. The recording medium P is not limited to cut paper, and may be a continuous roll paper. The recording medium P is not limited to paper, and may be a film or the like.

In the following description, the direction perpendicular to the liquid ejection surface of the liquid ejection head 11 shall be referred to as the Z direction (first direction). The longitudinal direction of the liquid ejection head 11 when viewed in the Z direction shall be referred to as the Y direction (second direction), and the transverse direction perpendicular to the longitudinal direction shall be referred to as the X direction (third direction). The liquid ejection head 11 ejects liquid in a direction along the Z direction.

A liquid communication portion 13, which is connected to a liquid supply system of the recording apparatus 10, is provided at both ends in the longitudinal direction (Y direction) of the liquid ejection head 11. The liquid supplied from a liquid containing portion of the recording apparatus 10 to the liquid communication portion 13 is ejected toward the recording medium P through a liquid flow path in the liquid ejection head 11. In an alternative configuration, the liquid may be recovered from inside the liquid ejection head 11 via the liquid communication portion 13. Such a configuration will allow the circulation of the liquid between the main body of the recording apparatus 10 and the liquid ejection head 11.

Hereinafter, a detailed configuration of the liquid ejection head 11 according to the present disclosure will be described in the form of various embodiments. The following embodiments differ from each other in the configuration of the liquid ejection substrate in which liquid flow paths are formed. Therefore, the following embodiments are described with respect to the configuration of the liquid ejection substrate in the liquid ejection head 11.

### Comparative Example

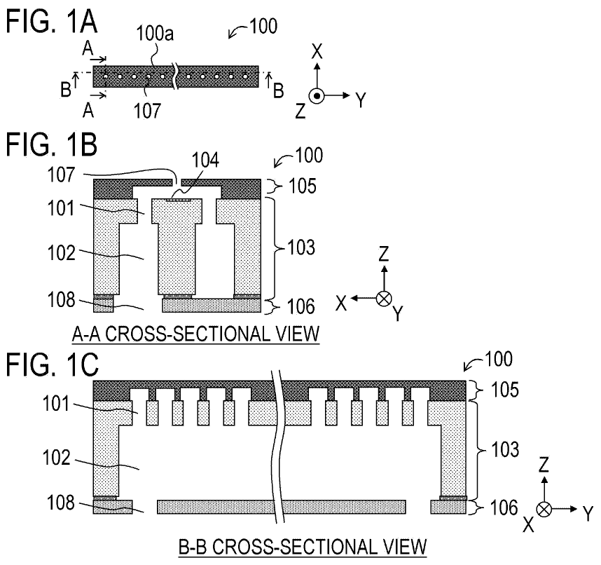

Before describing the embodiments of the present disclosure, the configuration of a liquid ejection substrate 100 in a liquid ejection head 11 according to a comparative example will be described with reference to FIG. 1A through FIG. 1C. FIG. 1A is a schematic plan view of the liquid ejection surface 100a of a liquid ejection substrate 100 according to the comparative example as viewed in the Z direction. FIG. 1B is a schematic cross-sectional view of a cross section A-A perpendicular to the Y direction of FIG. 1A. FIG. 1C is a schematic cross-sectional view of a cross section B-B perpendicular to the X direction of FIG. 1A. FIG. 1B and FIG. 1C each show the liquid flow paths in the liquid ejection substrate 100. The A-A cross section and B-B cross section respectively illustrate cross sections where nozzles 107 extend and where they do not.

As shown in FIG. 1A to FIG. 1C, the liquid ejection substrate 100 is configured by forming a thermoelectric module 104 and a nozzle layer 105 on top of a channel substrate 103 having individual supply ports 101 and a common liquid chamber 102, and by bonding a pitch conversion member 106 to the channel substrate. The nozzle layer 105 is a nozzle forming member having the liquid ejection surface, where nozzles 107 are formed as outlet ports for ejecting liquid such as ink. The pitch conversion member 106 is formed with a pitch conversion channel 108 as a connecting channel for supplying liquid to the common liquid chamber 102. Namely, the pitch conversion member 106 can be rephrased as a connecting channel forming member having a connecting channel formed therein. The pitch conversion channel 108, common liquid chamber 102, individual supply ports 101, and nozzles 107 constitute the liquid flow paths for the liquid to pass (flow) through, to be ejected from the liquid ejection head 11. In a configuration where the liquid is circulated, individual channels, such as individual recovery ports, similar to the individual supply ports 101, may be provided so that the nozzles 107 are in fluid communication with the common liquid chamber 102.

The channel substrate 103 is made of Si, for example. The common liquid chamber 102 may be formed by dry etching or wet etching. The shape of the common liquid chamber 102 is limited by the thickness of the channel substrate 103 and the properties of the dry or wet etching process. Accordingly, the restrictions on the shape and volume of the common liquid chamber 102 formed in the channel substrate 103 make it hard to simply increase the volume or make the shape more intricate.

The common liquid chamber 102 should preferably have a large volume from the perspectives of improving the efficiency of replenishing liquid to the nozzles 107 and of preventing crosstalk between adjacent nozzles. To prevent bubble accumulation and solute adhesion resulting from stagnation in the liquid flow, the chamber should preferably have a shape that eliminates portions that cause liquid flow stagnation. Some examples of configurations that can increase the degree of freedom in the design of the common liquid chamber will be described in discrete embodiments.

### First Embodiment

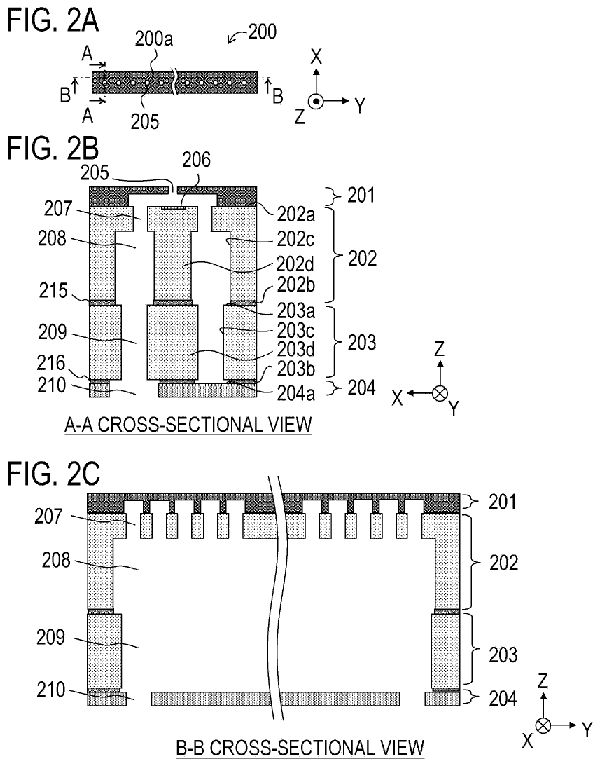

A liquid ejection substrate 200 in the liquid ejection head 11 according to the first embodiment will be described with reference to FIG. 2A through FIG. 2C. FIG. 2A is a schematic plan view of the liquid ejection surface 200a of the liquid ejection substrate 200 according to the first embodiment as viewed in the Z direction. FIG. 2B is a schematic cross-sectional view of a cross section A-A perpendicular to the Y direction of FIG. 2A. FIG. 2C is a schematic cross-sectional view of a cross section B-B perpendicular to the X direction of FIG. 2A. FIG. 2B and FIG. 2C each show the liquid flow paths in the liquid ejection head 11. The A-A cross section and B-B cross section respectively illustrate cross sections where nozzles 205 extend and where they do not.

### Configuration of Liquid Ejection Substrate in First Embodiment

The liquid ejection substrate 200 has a laminated structure including a nozzle layer 201, a first channel substrate 202, a second channel substrate 203, and a pitch conversion member 204. These components are laminated in the order of the nozzle layer 201, first channel substrate 202, second channel substrate 203, and pitch conversion member 204 in the Z direction. Namely, the lamination direction of the liquid ejection substrate 200 is parallel to the Z direction.

The liquid ejection substrate 200 includes nozzles 205, a thermoelectric module 206, individual supply ports 207, first common liquid chamber 208, second common liquid chamber 209, and pitch conversion channels 210. The nozzles 205 are formed in the nozzle layer 201 to open in the Z direction. The individual supply ports 207 and first common liquid chamber 208 are formed in the first channel substrate 202. The individual supply ports 207 are discrete channels open at one end in the Z direction and communicating with the flow paths formed in the nozzle layer 201. The first common liquid chamber 208 communicating with the individual supply ports 207 is open at the other end in the Z direction. The second common liquid chamber 209 is formed in the second channel substrate 203 and communicates with the first common liquid chamber 208. The pitch conversion channels 210 are connecting channels that are formed in the pitch conversion member 204 and communicate with the second common liquid chamber 209 for supplying the liquid to the common liquid chamber. In other words, the pitch conversion member 204 is a connecting channel converting member having a connecting channel formed therein. That is, in the first embodiment, the common liquid chamber of the liquid ejection substrate 200 is formed by the first common liquid chamber 208 and the second common liquid chamber 209. The thermoelectric module 206 is provided on the first channel substrate 202 at a position overlapping the nozzles 205 when viewed in the Z direction.

The first channel substrate 202 includes a first surface 202a connected to the nozzle layer 201, a second surface 202b connected to the second channel substrate 203, and a first wall portion 202c forming the individual supply ports 207 and the first common liquid chamber 208. The first surface 202a is a surface on which the individual supply ports 207 open. The second surface 202b is a surface on which the first common liquid chamber 208 opens. The first surface 202a and the second surface 202b face opposite directions.

The second channel substrate 203 includes a third surface 203a bonded to the second surface 202b of the first channel substrate 202 in the Z direction, a fourth surface 203b bonded to the pitch conversion member 204, and a second wall portion 203c forming the second common liquid chamber 209. The second common liquid chamber 209 opens on the third and fourth surfaces 203a and 203b. The third surface 203a and the fourth surface 203b face opposite directions.

The pitch conversion member 204 has a surface 204a bonded to the fourth surface 203b of the second channel substrate 203. The second and third surfaces 202b and 203a are bonded together via an adhesive 215, and the fourth surface 203b and the surface 204a are bonded together via an adhesive 216. The pitch conversion channels 210 open on the surface 204a.

The liquid flow paths in the liquid ejection substrate 200 are formed by the nozzles 205, individual supply ports 207, first common liquid chamber 208, second common liquid chamber 209, and pitch conversion channels 210. The liquid that has flown into the liquid flow path through the pitch conversion channel 210 flows into the individual supply ports 207 via the second common liquid chamber 209 and the first common liquid chamber 208, and is ejected from the nozzles 205 when the thermoelectric module 206 is activated.

The first channel substrate 202 has a plurality of individual supply ports 207 and a plurality of first common liquid chambers 208. As shown in FIG. 2B, a beam 202d that is a part of the first wall portion 202c is formed between two first common liquid chambers 208 in the X direction. Namely, the two first common liquid chambers 208 are separated in the X direction by the beam 202d. Similarly, two individual supply ports 207 are separated in the X direction by the beam 202d.

The second channel substrate 203 has a plurality of second common liquid chambers 209. As shown in FIG. 2B, a beam 203d that is a part of the second wall portion 203c is formed between two second common liquid chambers 209 in the X direction. Namely, the two second common liquid chambers 209 are separated in the X direction by the beam 203d. The beam 203d is wider in the X direction, i.e., thicker than the beam 202d.

As shown in FIG. 2C, the first common liquid chamber 208 is a space elongated in the Y direction, to which the plurality of individual supply ports 207 are connected. Similarly, the second common liquid chamber 209 is a space elongated in the Y direction, and is connected to the first common liquid chamber 208 and the pitch conversion channel 210.

The sectional areas perpendicular to the Z direction of the first and second common liquid chambers 208 and 209 are constant in the direction Z. In other words, the first wall portion 202c forming the first common liquid chamber 208 and the second wall portion 203c forming the second common liquid chamber 209 have wall surfaces that are each parallel to the Z direction. The first common liquid chamber 208 has a larger sectional area than that of the second common liquid chamber 209. Namely, the joint portion between the first wall portion 202c and the second wall portion 203c is discontinuous, i.e., the sectional areas of the first and second common liquid chambers 208 and 209 are different from each other in the joint portion between them. Thus, according to the configuration of the first embodiment, the common liquid chamber that forms the liquid flow paths in the liquid ejection head 11 is formed by two channel substrates. This allows for a greater degree of freedom in the design of the common liquid chamber. In the following description, unless otherwise specified, a “sectional area of the common liquid chamber” shall mean the area of a cross section perpendicular to the Z direction.

When compared with the configuration of the comparative example (FIG. 1A to FIG. 1C), the configuration of the first embodiment (FIG. 2A to FIG. 2C) allows the volume of the common liquid chamber in the liquid ejection head 11 to be increased, even if the liquid ejection substrate has the same thickness (length in the Z direction). This is because the first wall portion 202c including the beam 202d can be made thinner. In the configuration of the comparative example, the wall portion must entirely be made thinner in order to increase the volume of the common liquid chamber, which may significantly compromise the substrate strength. The substrate may then be unable to provide the necessary strength. In the configuration of the first embodiment, it is only the first wall portion 202c of the first channel substrate 202 that is made thinner. Therefore, the volume of the common liquid chamber can be increased without compromising substrate strength, so that the substrate can provide the necessary strength. This configuration can thus improve the performance of the liquid ejection head by enabling more efficient liquid replenishment to the nozzles and by preventing crosstalk between adjacent nozzles.

### Fabrication Method of Liquid Ejection Substrate in First Embodiment

A method for fabricating the liquid flow paths in the liquid ejection substrate 200 according to the first embodiment will be described. First, as a channel forming step, the individual supply ports 207 and the first common liquid chamber 208 are formed in the first channel substrate 202. The second common liquid chamber 209 is formed in the second channel substrate 203. The pitch conversion channels 210 are formed in the pitch conversion member 204. The first channel substrate 202, second channel substrate 203, and pitch conversion member 204 may be made of Si. Dry etching that uses a photoresist as a mask, wet etching, or other processing methods can be employed to form the channels.

Next, as a bonding step, the first channel substrate 202 and the second channel substrate 203 are bonded together, and the second channel substrate 203 and the pitch conversion member 204 are bonded together. The second surface 202b of the first channel substrate 202 and the third surface 203a of the second channel substrate 203 are bonded together via the adhesive 215. The fourth surface 203b of the second channel substrate 203 and the surface 204a of the pitch conversion member 204 are bonded together via the adhesive 216. The bonding step may use any bonding method that involves application of heat and pressure. The adhesives 215 and 216 are preferably made of a material having high adhesion. Preferably, the adhesive contains a resin selected from the group consisting of epoxy resin, acrylic resin, silicone resin, benzocyclobutene resin, polyamide resin, polyimide resin, and urethane resin.

Next, as a nozzle forming step, the nozzle layer 201 is formed on the first surface 202a of the first channel substrate 202. The nozzle layer 201 may be made of a negative photoresist, for example. The nozzles 205 are formed by exposure and development of the nozzle layer 201.

### Second Embodiment

The liquid ejection head 11 according to the second embodiment differs from the first embodiment in the relationship between the sectional areas of the first and second channel substrates. The following will focus on the differences in configuration between the first and second embodiments, omitting redundant descriptions of features that are the same or similar.

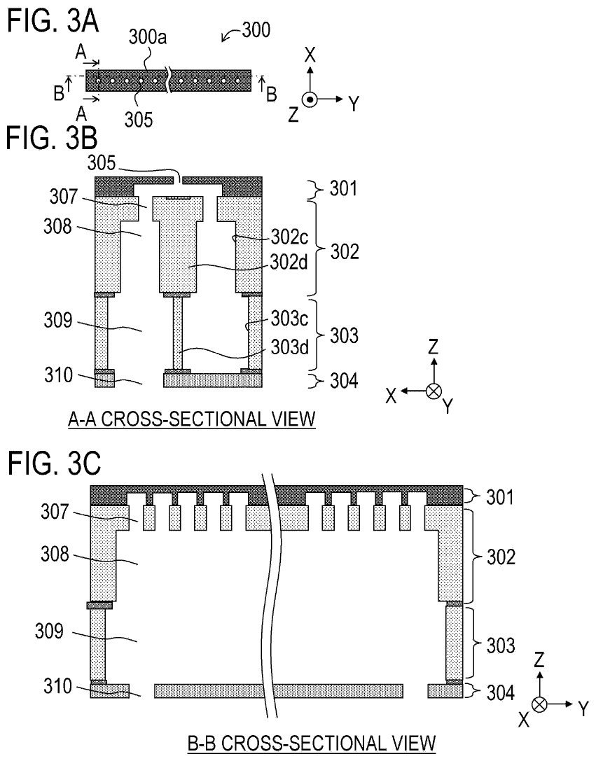

A liquid ejection substrate 300 in the liquid ejection head 11 according to the second embodiment will be described with reference to FIG. 3A through FIG. 3C. FIG. 3A is a schematic plan view of the liquid ejection surface 300a of the liquid ejection substrate 300 according to the second embodiment as viewed in the Z direction. FIG. 3B is a schematic cross-sectional view of a cross section A-A perpendicular to the Y direction of FIG. 3A. FIG. 3C is a schematic cross-sectional view of a cross section B-B perpendicular to the X direction of FIG. 3A. FIG. 3B and FIG. 3C each show the liquid flow paths in the liquid ejection head 11.

### Configuration of Liquid Ejection Substrate in Second Embodiment

The liquid ejection substrate 300 has a laminated structure including a nozzle layer 301, a first channel substrate 302, a second channel substrate 303, and a pitch conversion member 304. The liquid flow paths in the liquid ejection substrate 300 are formed by the nozzles 305 in the nozzle layer 301, individual supply ports 307 and a first common liquid chamber 308 in the first channel substrate 302, a second common liquid chamber 309 in the second channel substrate 303, and pitch conversion channels 310 in the pitch conversion member 304.

Similarly to the first embodiment, the first channel substrate 302 has a plurality of first common liquid chambers 308. As shown in FIG. 3B, a beam 302d that is a part of the first wall portion 302c of the first channel substrate 302 is formed between two first common liquid chambers 308 in the X direction. The second channel substrate 303 has a plurality of second common liquid chambers 309. A beam 303d that is a part of a second wall portion 303c of the second channel substrate 303 is formed between two second common liquid chambers 309 in the X direction. In the second embodiment, the beam 303d is narrower in the X direction and is thinner than the beam 302d.

The sectional areas perpendicular to the Z direction of the first and second common liquid chambers 308 and 309 are constant in the direction Z. In the second embodiment, the second common liquid chamber 309 has a larger sectional area than that of the first common liquid chamber 308. In other words, the joint portion between the first wall portion 302c and the second wall portion 303c is discontinuous, i.e., the sectional areas of the first and second common liquid chambers 308 and 309 are different from each other in the joint portion between them. Thus, according to the configuration of the second embodiment, the common liquid chamber that forms the liquid flow paths in the liquid ejection head 11 is formed by two channel substrates. This allows for a greater degree of freedom in the design of the common liquid chamber.

Similarly to the first embodiment, the configuration of the second embodiment also allows the volume of the common liquid chamber in the liquid ejection head 11 to be increased, when compared with the configuration of the comparative example. This is because the second wall portion 303c including the beam 303d can be made thinner. As shown, one of the first and second common liquid chambers may be configured to be extendable in order to increase the volume of the common liquid chamber. Such a configuration can improve the performance of the liquid ejection head by enabling more efficient liquid replenishment to the nozzles and by preventing crosstalk between adjacent nozzles.

In the first and second embodiments, the first common liquid chamber is larger or smaller in opening width in both the X and Y directions on the side facing the second common liquid chamber than the opening width of the second common liquid chamber on the side facing the first common liquid chamber. The configuration is not limited to this example. For example, the first common liquid chamber may have a larger opening width in the X direction than that of the second common liquid chamber and a smaller opening width in the Y direction than that of the second common liquid chamber. The effect of increasing the volume while ensuring the substrate strength is equally achieved even when the two chambers have different size relationships in the X and Y directions.

### Third Embodiment

The liquid ejection head 11 according to the third embodiment differs from the second embodiment in the shape of the wall portion of the second channel substrate. The following will focus on the differences in configuration between the second and third embodiments, omitting redundant descriptions of features that are the same or similar.

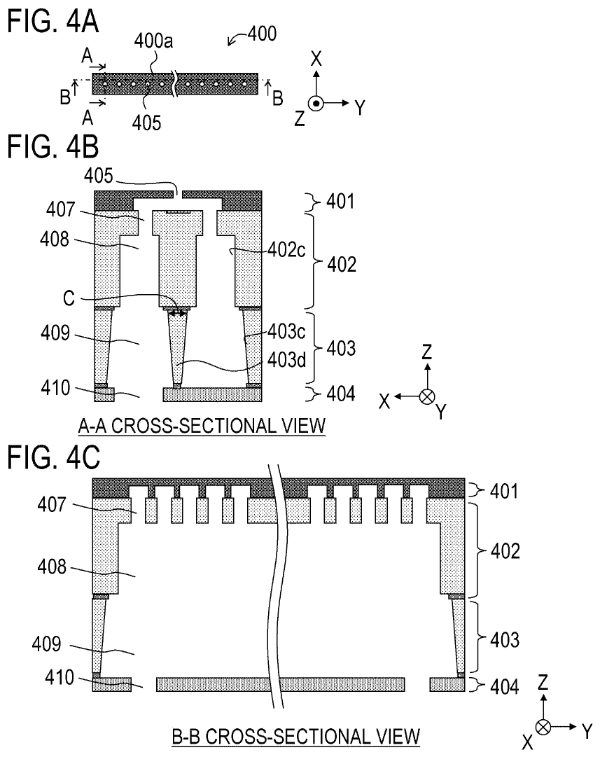

A liquid ejection substrate 400 in the liquid ejection head 11 according to the third embodiment will be described with reference to FIG. 4A through FIG. 4C. FIG. 4A is a schematic plan view of the liquid ejection surface 400a of the liquid ejection substrate 400 according to the third embodiment as viewed in the Z direction. FIG. 4B is a schematic cross-sectional view of a cross section A-A perpendicular to the Y direction of FIG. 4A. FIG. 4C is a schematic cross-sectional view of a cross section B-B perpendicular to the X direction of FIG. 4A. FIG. 4B and FIG. 4C each show the liquid flow paths in the liquid ejection head 11.

### Configuration of Liquid Ejection Substrate in Third Embodiment

The liquid ejection substrate 400 has a laminated structure including a nozzle layer 401, a first channel substrate 402, a second channel substrate 403, and a pitch conversion member 404. The liquid flow paths in the liquid ejection substrate 400 are formed by the nozzles 405 in the nozzle layer 401, individual supply ports 407 and a first common liquid chamber 408 in the first channel substrate 402, a second common liquid chamber 409 in the second channel substrate 403, and pitch conversion channels 410 in the pitch conversion member 404.

In the third embodiment, the second wall portion 403c of the second channel substrate 403 is configured such that the sectional area of the second common liquid chamber 409 gradually increases as it extends from the first common liquid chamber 408 (first channel substrate 402) to the pitch conversion channels 410 (pitch conversion member 404). That is, the second wall portion 403c including the beam 403d has a wall surface inclined relative to the Z direction. As described above, the second wall portion 403c includes a tapered surface that is inclined relative to the Z direction.

While the first common liquid chamber 408 has a constant sectional area in the Z direction, the second common liquid chamber 409 has a sectional area that gradually changes. The first wall portion 402c and the second wall portion 403c are configured so that the second common liquid chamber 409 has a consistently larger sectional area than that of the first common liquid chamber 408. Namely, the smallest sectional area of the second common liquid chamber 409, i.e., the sectional area (opening width) at the end facing the first common liquid chamber 408 in the Z direction, is larger than the sectional area (opening width) of the first common liquid chamber 408. The joint portion between the first wall portion 402c and the second wall portion 403c is discontinuous, i.e., the sectional areas of the first and second common liquid chambers 408 and 409 are different from each other in the joint portion between them. Thus, according to the configuration of the third embodiment, the common liquid chamber that forms the liquid flow paths in the liquid ejection head 11 is formed by two channel substrates. This allows for a greater degree of freedom in the design of the common liquid chamber. Such a configuration can improve the performance of the liquid ejection head by enabling more efficient liquid replenishment to the nozzles and by preventing crosstalk between adjacent nozzles.

According to the configuration of the third embodiment, when compared with the second embodiment, the beam 403d can be made wider (thickness C) in the X direction on the side facing the first channel substrate 402 while keeping the same volume of the second common liquid chamber. This is because the wall surface of the second wall portion 403c is inclined relative to the Z direction. Therefore, according to the configuration of the third embodiment, when compared with the second embodiment, the first and second channel substrates can be bonded together in a larger area, so that the bonding strength between them can be increased.

### Fourth Embodiment

The liquid ejection head 11 according to the fourth embodiment differs from the second embodiment in that protruded portions are formed in the second channel substrate. The following will focus on the differences in configuration between the second and fourth embodiments, omitting redundant descriptions of features that are the same or similar.

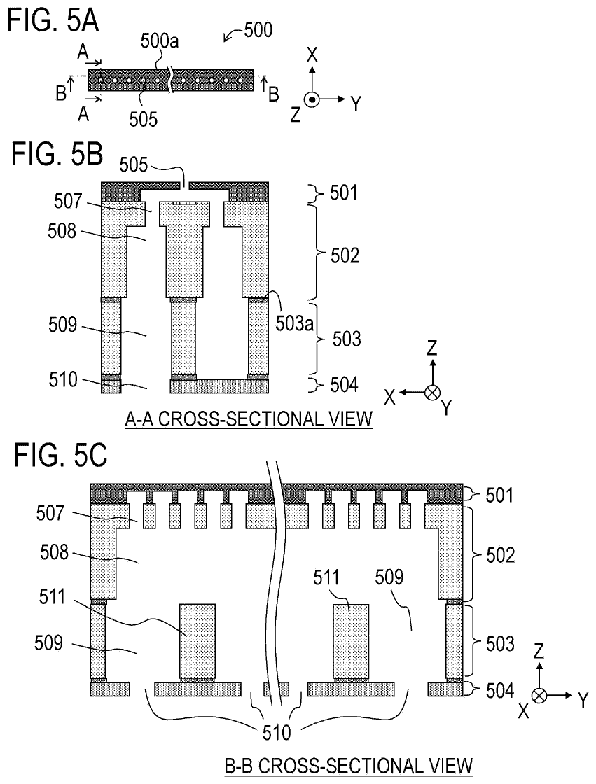

A liquid ejection substrate 500 in the liquid ejection head 11 according to the fourth embodiment will be described with reference to FIG. 5A through FIG. 5C. FIG. 5A is a schematic plan view of the liquid ejection surface 500a of the liquid ejection substrate 500 according to the fourth embodiment as viewed in the Z direction. FIG. 5B is a schematic cross-sectional view of a cross section A-A perpendicular to the Y direction of FIG. 5A. FIG. 5C is a schematic cross-sectional view of a cross section B-B perpendicular to the X direction of FIG. 5A. FIG. 5B and FIG. 5C each show the liquid flow paths in the liquid ejection head 11.

### Configuration of Liquid Ejection Substrate in Fourth Embodiment

The liquid ejection substrate 500 has a laminated structure including a nozzle layer 501, a first channel substrate 502, a second channel substrate 503, and a pitch conversion member 504. The liquid flow paths in the liquid ejection substrate 500 are formed by the nozzles 505 in the nozzle layer 501, individual supply ports 507 and a first common liquid chamber 508 in the first channel substrate 502, a second common liquid chamber 509 in the second channel substrate 503, and pitch conversion channels 510 in the pitch conversion member 504.

In the fourth embodiment, the second common liquid chamber 509 is provided with protruded portions 511 therein that project from the bottom surface of the second common liquid chamber 509 toward the first common liquid chamber 508 in the Z direction. In the fourth embodiment, the bottom surface of the second common liquid chamber 509 is a surface of the pitch conversion member 504 facing the same direction as the third surface 501a. As shown in FIG. 5C, the protruded portion 511 extends from one end (on the side facing the pitch conversion channel 510) to the other end (on the side facing the first common liquid chamber 508) of the second common liquid chamber 509.

The liquid ejection substrate 500 is formed with a plurality of protruded portions 511. The pitch conversion member 504 is formed with a plurality of pitch conversion channels 510 spaced apart in the Y direction. The protruded portions 511 are each located between two pitch conversion channels 510 arrayed in the Y direction.

When there are a plurality of pitch conversion channels 510, the liquid flow tends to be stagnant in the middle between two adjacent pitch conversion channels 510. Stagnant liquid flow can cause bubble accumulation and solute adhesion. The protruded portions 511 are a structure for controlling the liquid flow to reduce stagnation. Namely, the configuration of the fourth embodiment reduces liquid flow stagnation, which prevents bubble accumulation and solute adhesion.

FIG. 5C shows only one example of protruded portions 511. The shape, number, arrangement, and position of the protruded portions are not limited to the one shown in the drawings. For example, there may be a plurality of protruded portions 511 between two pitch conversion channels 510. The protruded portion 511 may have a polygonal or circular cross-sectional shape, and may be configured such that the sectional shape or area changes gradually in the extending direction.

### Fifth Embodiment

The liquid ejection head 11 according to the fifth embodiment differs from the first embodiment in that the liquid ejection substrate includes a third channel substrate. The following will focus on the differences in configuration between the first and fifth embodiments, omitting redundant descriptions of features that are the same or similar.

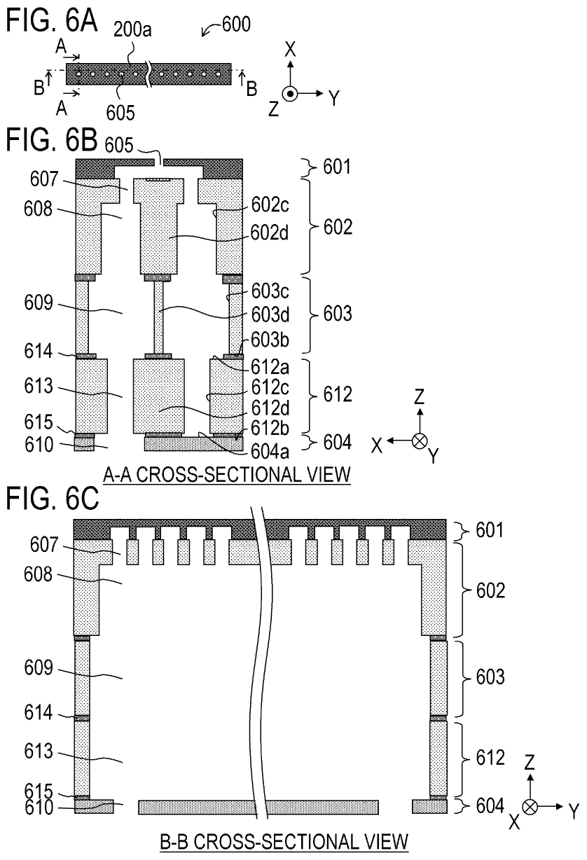

A liquid ejection substrate 600 in the liquid ejection head 11 according to the fifth embodiment will be described with reference to FIG. 6A through FIG. 6C. FIG. 6A is a schematic plan view of the liquid ejection surface 600a of the liquid ejection substrate 600 according to the fifth embodiment as viewed in the Z direction. FIG. 6B is a schematic cross-sectional view of a cross section A-A perpendicular to the Y direction of FIG. 6A. FIG. 6C is a schematic cross-sectional view of a cross section B-B perpendicular to the X direction of FIG. 6A. FIG. 6B and FIG. 6C each show the liquid flow paths in the liquid ejection head 11.

### Configuration of Liquid Ejection Substrate in Fifth Embodiment

The liquid ejection substrate 600 has a laminated structure including a nozzle layer 601, a first channel substrate 602, a second channel substrate 603, a third channel substrate 612, and a pitch conversion member 604. These components are laminated in the order of the nozzle layer 601, first channel substrate 602, second channel substrate 603, third channel substrate 612, and pitch conversion member 604 in the Z direction. The liquid flow paths in the liquid ejection substrate 600 are formed by the nozzles 605 in the nozzle layer 601, individual supply ports 607 and a first common liquid chamber 608 in the first channel substrate 602, a second common liquid chamber 609 in the second channel substrate 603, a third common liquid chamber 613 in the third channel substrate 612, and pitch conversion channels 610 in the pitch conversion member 604.

The third common liquid chamber 613 is a space elongated in the Y direction, and is connected to the second common liquid chamber 609 at one end in the Z direction and to the pitch conversion channel 610 at the other end. That is, in the fifth embodiment, the common liquid chamber of the liquid ejection substrate 600 is formed by the first common liquid chamber 608, second common liquid chamber 609, and third common liquid chamber 613.

The third channel substrate 612 includes a fifth surface 612a connected to the fourth surface 603b of the second channel substrate 603, a sixth surface 612b to which the pitch conversion member 604 is connected, and a third wall portion 612c forming the third common liquid chamber 613. The fifth surface 612a and the sixth surface 612b face opposite directions. The fourth surface 603b and the fifth surface 612a are bonded together via an adhesive 614, and the sixth surface 612b and the surface 604 a of the pitch conversion member 604 are bonded together via an adhesive 615.

The third channel substrate 612 has a plurality of third common liquid chambers 613. As shown in FIG. 6B, a beam 612d that is a part of the third wall portion 612c of the third channel substrate 612 is formed between two third common liquid chambers 613 in the X direction.

In the fifth embodiment, the beam 612d of the third channel substrate 612 is wider in the X direction than the beam 602d of the first channel substrate 602 and the beam 603d of the second channel substrate 603. Namely, the configuration of the fifth embodiment is achieved by increasing the thickness of part of the second wall portion 203c of the second channel substrate 203 in the configuration of the second embodiment (FIG. 3A to FIG. 3C).

The sectional area perpendicular to the Z direction of the third common liquid chamber 613 is constant in the direction Z. That is, the third common liquid chamber 613 has a smaller sectional area than that of the first common liquid chamber 608 and second common liquid chamber 609. More specifically, the opening width in the X direction of the third common liquid chamber 613 is smaller than that of the first common liquid chamber 608 and second common liquid chamber 609. The opening width in the Y direction of the third common liquid chamber 613 is smaller than that of the first common liquid chamber 608 and the same as that of the second common liquid chamber 609. Therefore, the sectional areas of the second common liquid chamber 609 and the third common liquid chamber 613 are different from each other in the joint portion between them. The joint portion between the second wall portion 603c and the third wall portion 612c includes a discontinuous part. More specifically, while both end faces in the X direction of the second common liquid chamber 609 and the third common liquid chamber 613 are discontinuous, their end faces in the Y direction are continuous via the adhesive 614, i.e., flush with each other.

As described above, this configuration with the third channel substrate 612 sandwiching the second channel substrate 603 between itself and the first channel substrate 602 enables the beam 603d of the second channel substrate 603 to be made thinner to increase the volume of the second common liquid chamber 609, while allowing the beams 602d and 612d of the first and third channel substrates 602 and 612 to remain thick to ensure strength. As a result, this configuration allows the common liquid chamber (first, second, and third common liquid chambers 608, 609, and 613) in the liquid ejection substrate 600 to have a greater volume while ensuring the substrate strength. Therefore, such a configuration can improve the performance of the liquid ejection head by enabling more efficient liquid replenishment to the nozzles and by preventing crosstalk between adjacent nozzles.

### Sixth Embodiment

The liquid ejection head 11 according to the sixth embodiment differs from the second embodiment in that a bubble trap filter is provided in a bonded portion between the first and second channel substrates. The following will focus on the differences in configuration between the second and sixth embodiments, omitting redundant descriptions of features that are the same or similar.

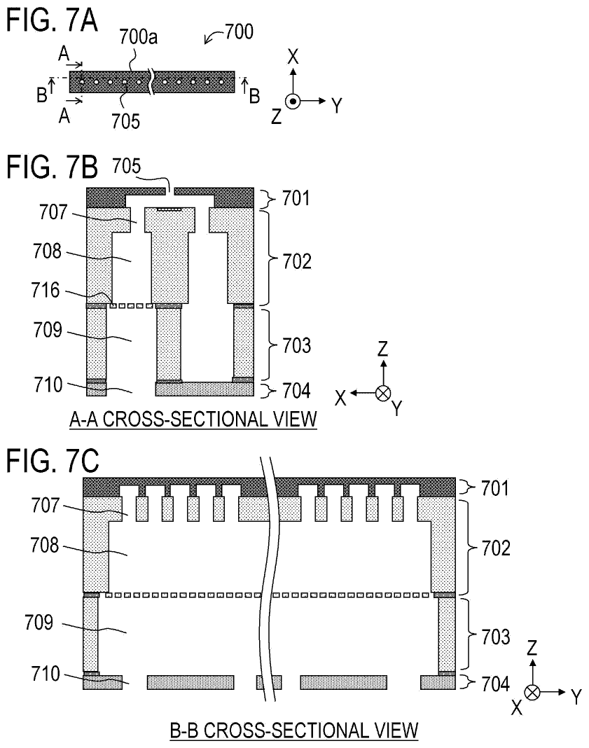

A liquid ejection substrate 700 in the liquid ejection head 11 according to the sixth embodiment will be described with reference to FIG. 7A through FIG. 7C. FIG. 7A is a schematic plan view of the liquid ejection surface 700a of the liquid ejection substrate 700 according to the sixth embodiment as viewed in the Z direction. FIG. 7B is a schematic cross-sectional view of a cross section A-A perpendicular to the Y direction of FIG. 7A. FIG. 7C is a schematic cross-sectional view of a cross section B-B perpendicular to the X direction of FIG. 7A. FIG. 7B and FIG. 7C each show the liquid flow paths in the liquid ejection head 11.

### Configuration of Liquid Ejection Substrate in Sixth Embodiment

The liquid ejection substrate 700 has a laminated structure including a nozzle layer 701, a first channel substrate 702, a second channel substrate 703, and a pitch conversion member 704. The liquid flow paths in the liquid ejection substrate 700 are formed by the nozzles 705 in the nozzle layer 701, individual supply ports 707 and a first common liquid chamber 708 in the first channel substrate 702, a second common liquid chamber 709 in the second channel substrate 703, and pitch conversion channels 710 in the pitch conversion member 704.

In the sixth embodiment, a bubble trap filter 716 is provided between the first channel substrate 702 and the second channel substrate 703. The bubble trap filter 716 catches air bubbles contained in the liquid such as ink flowing from the second common liquid chamber 709 to the first common liquid chamber 708. The bubble trap filter 716 minimizes entry of air bubbles into the nozzles 705. A resin material such as polyimide, for example, may be used preferably for the bubble trap filter 716.

FIG. 7B illustrates a configuration in which the bubble trap filter 716 is provided in the joint portion between the first common liquid chamber 708 and the second common liquid chamber 709 where the liquid flows from the second common liquid chamber 709 to the first common liquid chamber 708. On the other hand, in a portion where the liquid flows from the first common liquid chamber 708 to the second common liquid chamber 709, the bubble trap filter 716 is not provided in the sixth embodiment. This portion where no bubble trap filter 716 is provided is a channel for recovering the liquid that was not ejected from the nozzles 705. Namely, the bubble trap filter 716 is not necessarily provided in the flow paths extending from the channels formed in the nozzle layer 701 to the second common liquid chamber 709 via individual recovery ports and the first common liquid chamber 708 in the first channel substrate 702. The bubble trap filter 716 is preferably placed in accordance with liquid flow directions in this way.

### Seventh Embodiment

The liquid ejection head 11 of the seventh embodiment differs from the first embodiment in that the second channel substrate and the pitch conversion member are formed in one piece. The following will focus on the differences in configuration between the first and seventh embodiments, omitting redundant descriptions of features that are the same or similar.

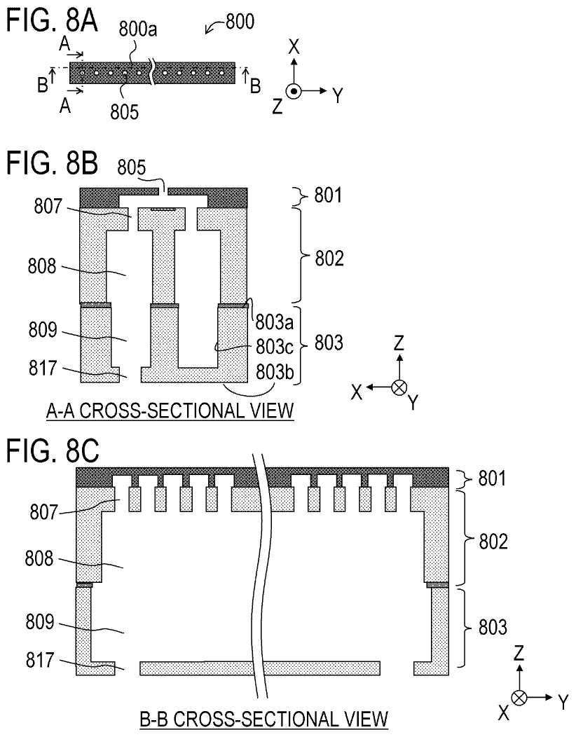

A liquid ejection substrate 800 in the liquid ejection head 11 according to the seventh embodiment will be described with reference to FIG. 8A through FIG. 8C. FIG. 8A is a schematic plan view of the liquid ejection surface 800a of the liquid ejection substrate 800 according to the seventh embodiment as viewed in the Z direction. FIG. 8B is a schematic cross-sectional view of a cross section A-A perpendicular to the Y direction of FIG. 8A. FIG. 8C is a schematic cross-sectional view of a cross section B-B perpendicular to the X direction of FIG. 8A. FIG. 8B and FIG. 8C each show the liquid flow paths in the liquid ejection head 11.

### Configuration of Liquid Ejection Substrate in Seventh Embodiment

The liquid ejection substrate 800 has a laminated structure including a nozzle layer 801, a first channel substrate 802, and a second channel substrate 803. The liquid flow paths in the liquid ejection substrate 800 are formed by the nozzles 805 in the nozzle layer 801, individual supply ports 807 and a first common liquid chamber 808 in the first channel substrate 802, and a second common liquid chamber 809 and pitch conversion channels 817 in the second channel substrate 803.

In the seventh embodiment, the liquid ejection substrate 800 does not have a pitch conversion member. Instead, the pitch conversion channels 817 are formed in the second channel substrate 803. Namely, the configuration of the seventh embodiment is achieved by forming the second channel substrate 203 and the pitch conversion member 204 in one piece in the configuration of the first embodiment (FIG. 2A to FIG. 2C).

The second common liquid chamber 809 and the pitch conversion channels 817 are formed in the second channel substrate 803. Namely, the second wall portion 803c of the second channel substrate 803 forms the pitch conversion channels 817 as well as the second common liquid chamber 809. The second common liquid chamber 809 opens on the third surface 803a of the second channel substrate 803 and communicates with the first common liquid chamber 808. The pitch conversion channels 817 communicating with the second common liquid chamber 809 open on the fourth surface 803b of the second channel substrate 803. The fourth surface 803b faces the outside of the liquid ejection substrate 800.

The second channel substrate 803 according to the seventh embodiment can be fabricated by forming the second common liquid chamber 809 from the third surface 803a side, and by forming the pitch conversion channels 817 from the fourth surface 803b side. The second common liquid chamber 809 and pitch conversion channels 817 may be formed preferably by dry etching, using a photoresist as a mask. This method enables the formation of wall surfaces that define the channels parallel to the Z direction, and allows the fabrication of the second common liquid chamber 809 and the pitch conversion channels 817 having a constant sectional area in the Z direction.

This configuration enables the omission of the bonding step for bonding the pitch conversion member, so that the fabrication process is more simple than the first embodiment. Moreover, similarly to the first embodiment, this configuration can improve the performance of the liquid ejection head by enabling more efficient liquid replenishment to the nozzles and by preventing crosstalk between adjacent nozzles.

### Eighth Embodiment

The liquid ejection head 11 according to the eighth embodiment differs from the seventh embodiment in the shape of the channels in the second channel substrate. The following will focus on the differences in configuration between the seventh and eighth embodiments, omitting redundant descriptions of features that are the same or similar.

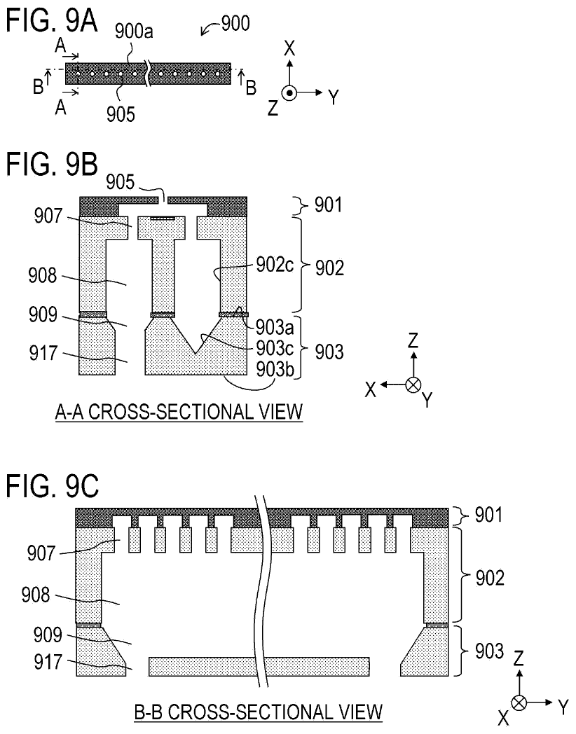

A liquid ejection substrate 900 in the liquid ejection head 11 according to the eighth embodiment will be described with reference to FIG. 9A through FIG. 9C. FIG. 9A is a schematic plan view of the liquid ejection surface 900a of the liquid ejection substrate 900 according to the eighth embodiment as viewed in the Z direction. FIG. 9B is a schematic cross-sectional view of a cross section A-A perpendicular to the Y direction of FIG. 9A. FIG. 9C is a schematic cross-sectional view of a cross section B-B perpendicular to the X direction of FIG. 9A FIG. 9B and FIG. 9C each show the liquid flow paths in the liquid ejection head 11.

### Configuration of Liquid Ejection Substrate in Eighth Embodiment

The liquid ejection substrate 900 has a laminated structure including a nozzle layer 901, a first channel substrate 902, and a second channel substrate 903. The liquid flow paths in the liquid ejection substrate 900 are formed by the nozzles 905 in the nozzle layer 901, individual supply ports 907 and a first common liquid chamber 908 in the first channel substrate 902, and a second common liquid chamber 909 and pitch conversion channels 917 in the second channel substrate 903.

In the eighth embodiment, similarly to the seventh embodiment, the liquid ejection substrate 900 does not have a pitch conversion member. Instead, the pitch conversion channels 917 are formed in the second channel substrate 903. In the eighth embodiment, the second wall portion 903c of the second channel substrate 903 is configured such that the sectional area of the second common liquid chamber 909 gradually decreases as it extends from the first common liquid chamber 908 (first channel substrate 902) to the pitch conversion channels 917. That is, the second wall portion 903c of the second channel substrate 903 has a wall surface inclined relative to the Z direction. In other words, the second wall portion 903c includes a tapered surface that is inclined relative to the Z direction.

While the first common liquid chamber 908 has a constant sectional area in the Z direction, the second common liquid chamber 909 has a sectional area that gradually changes. The joint portion between the first wall portion 902c and the second wall portion 903c is discontinuous, i.e., the sectional areas of the first and second common liquid chambers 908 and 909 are different from each other in the joint portion between them. The second wall portion 903c is configured so that the sectional area of the second common liquid chamber 909 gradually decreases as it extends away from the first common liquid chamber 908. Note, the first common liquid chamber 908 and the second common liquid chamber 909 may have the same sectional area in the joint portion between them, with the same opening widths in both the X and Y directions.

The second channel substrate 903 according to the eighth embodiment can be fabricated by forming the second common liquid chamber 909 from the third surface 903a side, and by forming the pitch conversion channels 917 from the fourth surface 903b side. Wet etching is preferable for forming the second common liquid chamber 909, while dry etching is preferable for forming the pitch conversion channels 917. These fabrication methods allow the fabrication of the second common liquid chamber 909 having a sectional area that changes in the Z direction, and the pitch conversion channels 917 having a constant sectional area in the Z direction, within one substrate.

This configuration simplifies the fabrication process compared to the first embodiment. Even though the pitch conversion channels are formed in the second channel substrate in the eighth embodiment, this configuration allows for a greater degree of freedom in the design, because the common liquid chamber that forms the liquid flow paths in the liquid ejection head 11 is formed by two channel substrates. Such a configuration can improve the performance of the liquid ejection head by enabling more efficient liquid replenishment to the nozzles and by preventing crosstalk between adjacent nozzles.

### Ninth Embodiment

The liquid ejection head 11 according to the ninth embodiment differs from the eighth embodiment in the shape of the channels in the second channel substrate. The following will focus on the differences in configuration between the eighth and ninth embodiments, omitting redundant descriptions of features that are the same or similar.

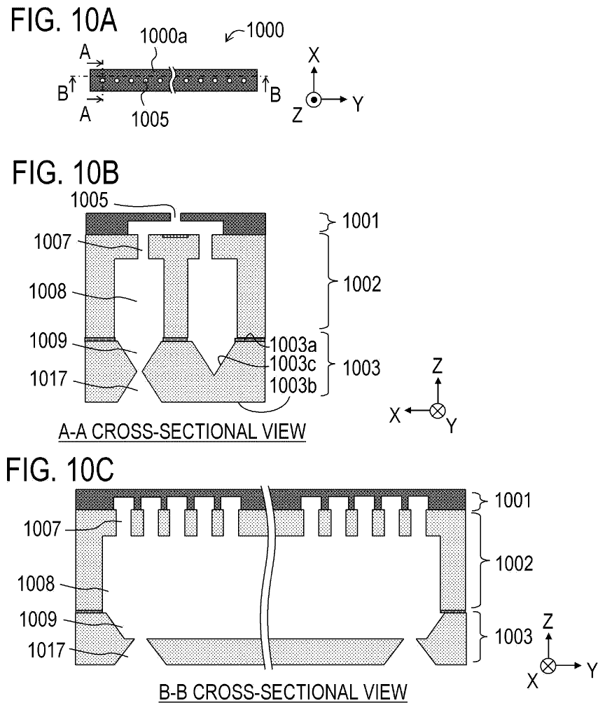

A liquid ejection substrate 1000 in the liquid ejection head 11 according to the ninth embodiment will be described with reference to FIG. 10A through FIG. 10C. FIG. 10A is a schematic plan view of the liquid ejection surface 1000a of the liquid ejection substrate 1000 according to the ninth embodiment as viewed in the Z direction. FIG. 10B is a schematic cross-sectional view of a cross section A-A perpendicular to the Y direction of FIG. 10A. FIG. 10C is a schematic cross-sectional view of a cross section B-B perpendicular to the X direction of FIG. 10A. FIG. 10B and FIG. 10C each show the liquid flow paths in the liquid ejection head 11.

### Configuration of Liquid Ejection Substrate in Ninth Embodiment

The liquid ejection substrate 1000 has a laminated structure including a nozzle layer 1001, a first channel substrate 1002, and a second channel substrate 1003. The liquid flow paths in the liquid ejection substrate 1000 are formed by the nozzles 1005 in the nozzle layer 1001, individual supply ports 1007 and a first common liquid chamber 1008 in the first channel substrate 1002, and a second common liquid chamber 1009 and pitch conversion channels 1017 in the second channel substrate 1003.

In the ninth embodiment, the second wall portion 1003c of the second channel substrate 1003 is configured such that the sectional area of the pitch conversion channels 1017 gradually increases as they extend away from the second common liquid chamber 1009. Namely, in the ninth embodiment, wall surfaces of the second wall portion 1003c forming the second common liquid chamber 1009 and the pitch conversion channels 1017 are both inclined relative to the Z direction.

The second channel substrate 1003 according to the ninth embodiment can be fabricated by forming the second common liquid chamber 1009 from the third surface 1003a side, and by forming the pitch conversion channels 1017 from the fourth surface 1003b side. The second common liquid chamber 1009 and pitch conversion channels 1017 are formed preferably by wet etching. The second channel substrate 1003 according to the ninth embodiment is a silicon substrate having the <100> crystal plane orientation. The second wall portion 1003c is formed by wet etching to expose the <111> plane so that the wall surface is tapered at an angle of 54.7°.

The pitch conversion channels 1017 are formed to enlarge (increase in sectional area) as they extend from the second common liquid chamber 1009 to the fourth surface 1003b, so that air bubbles that enter the pitch conversion channels 1017 from the second common liquid chamber 1009 are more readily kept away from the nozzles 1005. This helps to minimize a decrease in the ejection performance caused by air bubbles.

### Tenth Embodiment

The liquid ejection head 11 according to the tenth embodiment differs from the ninth embodiment in the shape of the channels in the second channel substrate. The following will focus on the differences in configuration between the ninth and tenth embodiments, omitting redundant descriptions of features that are the same or similar.

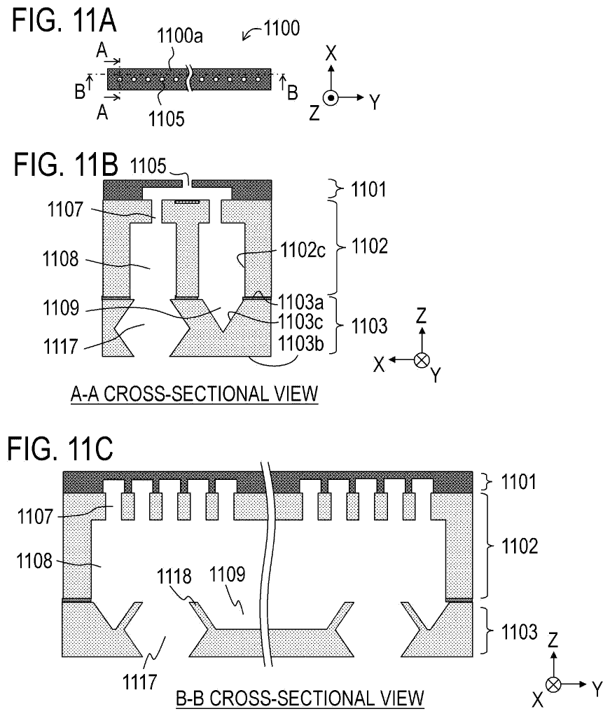

A liquid ejection substrate 1100 in the liquid ejection head 11 according to the tenth embodiment will be described with reference to FIG. 11A through FIG. 11C. FIG. 11A is a schematic plan view of the liquid ejection surface 1100a of the liquid ejection substrate 1100 according to the tenth embodiment as viewed in the Z direction. FIG. 11B is a schematic cross-sectional view of a cross section A-A perpendicular to the Y direction of FIG. 11A. FIG. 11C is a schematic cross-sectional view of a cross section B-B perpendicular to the X direction of FIG. 11A. FIG. 11B and FIG. 11C each show the liquid flow paths in the liquid ejection head 11.

### Configuration of Liquid Ejection Substrate in Tenth Embodiment

The liquid ejection substrate 1100 has a laminated structure including a nozzle layer 1101, a first channel substrate 1102, and a second channel substrate 1103. The liquid flow paths in the liquid ejection substrate 1100 are formed by the nozzles 1105 in the nozzle layer 1101, individual supply ports 1107 and a first common liquid chamber 1108 in the first channel substrate 1102, and a second common liquid chamber 1109 and pitch conversion channels 1117 in the second channel substrate 1103.

In the tenth embodiment, the second common liquid chamber 1109 and the pitch conversion channels 1117 are not directly in communication (connected) with each other, and are separately formed. As shown in FIG. 11B, in the cross section perpendicular to the Y direction, the second common liquid chamber 1109 and the pitch conversion channels 1117 are separated by a second wall portion 1103c in the X direction. Namely, the second common liquid chamber 1109 and the pitch conversion channels 1117 are side by side in the X direction. As shown in FIG. 11C, in the cross section perpendicular to the X direction, the second common liquid chamber 1109 and the pitch conversion channels 1117 are separated by a protruded portion 1118 in the Y direction. Namely, the second common liquid chamber 1109 and the pitch conversion channels 1117 are arranged side by side in the Y direction.

The second common liquid chamber 1109 opens on the third surface 1103a of the second channel substrate 1103 and communicates with the first common liquid chamber 1108. On the other hand, the pitch conversion channels 1117 open on the third surface 1103a of the second channel substrate 1103 to communicate with the first common liquid chamber 1108, and open on the fourth surface 1103b to communicate with the outside of the liquid ejection substrate 1100. The joint portion between the first wall portion 1102c and the second wall portion 1103c is discontinuous, i.e., the sectional areas of the first and second common liquid chambers 1108 and 1109 are different from each other in the joint portion between them. Similarly, the sectional areas of the first common liquid chamber 1108 and the pitch conversion channel 1117 are different from each other in the joint portion between them. Alternatively, they may have the same sectional area.

The protruded portion 1118 is formed on the bottom surface of the second channel substrate 1103 and projects toward the first common liquid chamber 1108 at an angle relative to the Z direction. The bottom surface of the second channel substrate 1103 forms a wall surface of the second common liquid chamber 1109. The protruded portion 1118 forms a part of a wall of the second common liquid chamber 1109 and the pitch conversion channels 1117. Namely, the protruded portion 1118 can be considered as part of the second wall portion 1103c of the second channel substrate 1103.

In the tenth embodiment, the second wall portion 1103c of the second channel substrate 1103 is configured such that the sectional area of the pitch conversion channels 1117 gradually increases as they extend away from the second common liquid chamber 1109, and decreases gradually from a halfway point. Namely, the pitch conversion channel 1117 is substantially hexagonal in a cross section perpendicular to the X direction or in a cross section perpendicular to the Y direction.

The second channel substrate 1103 according to the tenth embodiment can be fabricated by forming the second common liquid chamber 1109 and the pitch conversion channels 1117 by wet etching. The second channel substrate 1103 according to the tenth embodiment is a silicon substrate having the <100> crystal plane orientation. The second wall portion 1103c is formed by wet etching to expose the <111> plane so that the wall surface is tapered at an angle of 54.7°. The configuration is not limited to this example. The pitch conversion channels 1117 may be formed by dry etching instead, so that the pitch conversion channels 1117 alone extend straight in the Z direction.

The protruded portion 1118 reduces liquid flow stagnation similarly to the fourth embodiment, which helps prevent bubble accumulation and solute adhesion. Namely, the presence of the protruded portion 1118 transforms the laminar flow of liquid during the printing and recovery sequences into a turbulent flow. This stirs the liquid inside the liquid ejection substrate 1110, accelerating the discharge of air bubbles from inside the common liquid chamber.

Furthermore, in the tenth embodiment, the second common liquid chamber 1109 and the pitch conversion channels 1117 are formed separately, which allows for better control of their shapes. As a result, the desired shapes can be formed more consistently, which enables the formation of an even more intricate structure.

### Eleventh Embodiment

The liquid ejection head 11 according to the eleventh embodiment differs from the tenth embodiment in the configuration of the second common liquid chamber. The following will focus on the differences in configuration between the tenth and eleventh embodiments, omitting redundant descriptions of features that are the same or similar.

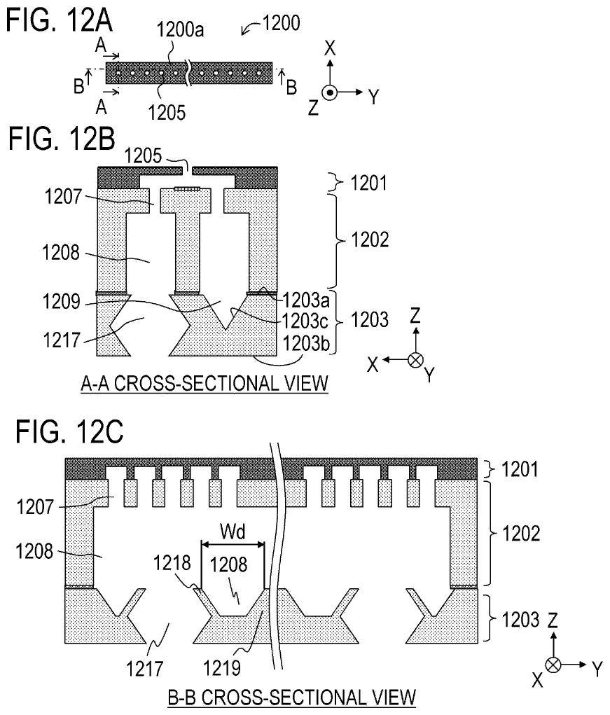

A liquid ejection substrate 1200 in the liquid ejection head 11 according to the eleventh embodiment will be described with reference to FIG. 12A through FIG. 12C. FIG. 12A is a schematic plan view of the liquid ejection surface 1200a of the liquid ejection substrate 1200 according to the eleventh embodiment as viewed in the Z direction. FIG. 12B is a schematic cross-sectional view of a cross section A-A perpendicular to the Y direction of FIG. 12A. FIG. 12C is a schematic cross-sectional view of a cross section B-B perpendicular to the X direction of FIG. 12A. FIG. 12B and FIG. 12C each show the liquid flow paths in the liquid ejection head 11.

### Configuration of Liquid Ejection Substrate in Eleventh Embodiment

The liquid ejection substrate 1200 has a laminated structure including a nozzle layer 1201, a first channel substrate 1202, and a second channel substrate 1203. The liquid flow paths in the liquid ejection substrate 1200 are formed by the nozzles 1205 in the nozzle layer 1201, individual supply ports 1207 and a first common liquid chamber 1208 in the first channel substrate 1202, and a second common liquid chamber 1209 and pitch conversion channels 1217 in the second channel substrate 1203.

The second common liquid chamber 1209 opens on the third surface 1203a of the second channel substrate 1203 and communicates with the first common liquid chamber 1208. On the other hand, the pitch conversion channels 1217 open on the third surface 1203a of the second channel substrate 1203 to communicate with the first common liquid chamber 1208, and open on the fourth surface 1203b to communicate with the outside of the liquid ejection substrate 1200.

In the eleventh embodiment, the second common liquid chamber 1209 is divided into a plurality of sections by a protruded portion 1219. In other words, a plurality of second common liquid chambers 1209 are arranged along the Y direction with the protruded portion 1219 interposed therebetween. Namely, the configuration of the eleventh embodiment is achieved by dividing the second common liquid chamber 1109 in the tenth embodiment into a plurality of sections in the Y direction.

The second common liquid chamber 1209 is formed by a wall portion that includes the protruded portion 1219, and a protruded portion 1218 separating the second common liquid chamber 1209 from the pitch conversion channels 1217. Namely, the protruded portion 1218 can be considered as part of the second wall portion 1203c of the second channel substrate 1203. Similarly to the protruded portion 1218, the protruded portion 1219 is formed on the bottom surface of the second channel substrate 1203 and projects toward the first common liquid chamber 1208 at an angle relative to the Z direction.

This configuration includes more protruded portions than in the tenth embodiment and provides increased effect of preventing liquid stagnation. The protruded portion 1219 is preferably formed such that the opening width Wd in the Y direction of the second common liquid chamber 1209 is not more than 2 mm at the end on the side facing the first common liquid chamber 1208.

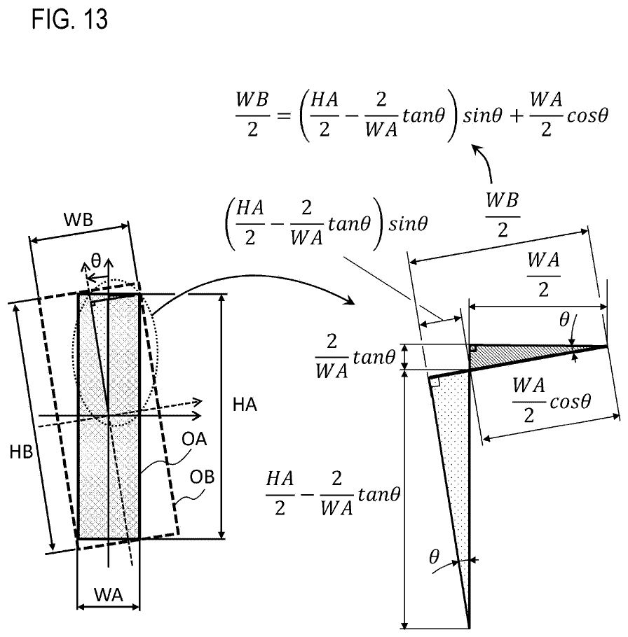

When the silicon substrate is processed by wet etching, a misalignment in the orientation of the hole pattern relative to the crystal orientation of the silicon substrate affects the opening width. The relationship between the misalignment and the opening width will be described. FIG. 13 is an illustrative diagram explaining the relationship between the orientation misalignment and the opening width.

FIG. 13 shows an opening OB formed when there is an orientation misalignment of θ relative to an opening OA of an ideal shape. The opening OA is rectangular, with its longitudinal and transverse dimensions denoted at HA and WA, respectively. The opening OB is rectangular, with its longitudinal and transverse dimensions denoted at HB and WB, respectively. In FIG. 13, the opening OA is outlined by solid lines and filled in with hatches. The opening OB is outlined by dotted lines. FIG. 13 also shows a diagram illustrating an equation of the relationship between WA and WB.

As shown in FIG. 13, WB/2 is determined by the sum of (WA/2)cosθ and {HA/2−(2/WA)tanθ}sinθ. Namely, when 0°≤θ<45° and HA is substantially larger than WA, the greater HA is, the greater WB is, and the greater the difference between WB and WA (WB−WA) is. As shown, a large longitudinal dimension of the opening tends to lead to a large amount of displacement in the transverse dimension when the orientation is misaligned. Therefore, separating the second common liquid chamber into plural sections as in the eleventh embodiment enables more precise formation of openings.

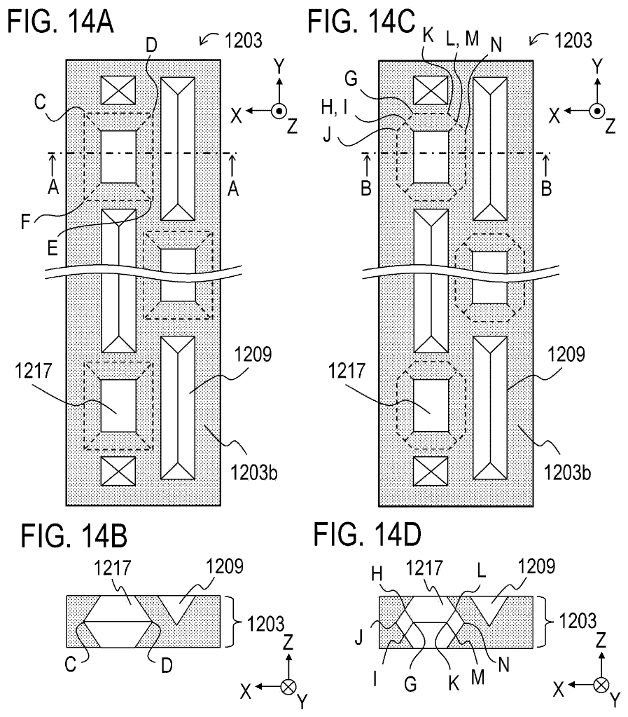

Next, configuration examples of the second channel substrate 1203 will be described. The second channel substrate 1203 of the eleventh embodiment will be described as an example. FIG. 14A to FIG. 14D are illustrative diagrams of configuration examples of the second channel substrate 1203 according to the eleventh embodiment. FIG. 14A is a plan view of the first configuration example of the second channel substrate 1203 according to the eleventh embodiment as viewed from the fourth surface 1203b side. FIG. 14B is a schematic cross-sectional view of a cross section A-A perpendicular to the Y direction of FIG. 14A. FIG. 14C is a plan view of the second configuration example of the second channel substrate 1203 according to the eleventh embodiment as viewed from the fourth surface 1203b side. FIG. 14D is a schematic cross-sectional view of a cross section A-A perpendicular to the Y direction of FIG. 14C.

The pitch conversion channel 1217 according to the first configuration example is a decahedron space including the planes with openings (openings on the third surface 1203a and the fourth surface 1203b). FIG. 14A and FIG. 14B illustrate the vertices C and D of the decahedron-shaped pitch conversion channel 1217. FIG. 14A also shows the vertices E and F of the decahedron. During the formation of the pitch conversion channels by wet etching, a crystal plane with a lower etching rate acts as an etch stop when it is exposed. The second channel substrate 1203 is etched through until an etch stop, whereby a decahedron-shaped space is formed as the pitch conversion channel 1217 in Example 1. In this case, all the eight faces where silicon is exposed are the <111> plane. When this configuration is subjected to pressure from a surface of the second channel substrate 1203 (fourth surface 1203b), the stress concentrates at four vertices C, D, E, and F. Such stress concentration can lead to breakage of the substrate.

The pitch conversion channel 1217 of Example 2 is a tetradecahedron space including the planes with openings (openings on the third surface 1203a and the fourth surface 1203b). FIG. 14C and FIG. 14D show vertices G, H, I, J K L M, and N of the tetradecahedron of the pitch conversion channel 1217. The tetradecahedron includes a rectangular face formed by vertices G, H, I, and J, and a rectangular face formed by vertices K, L, M, and N. The pitch conversion channel 1217 can be formed to include the rectangles GHIJ and KLMN, which are the <100> plane, by stopping the etching before the vertices C, D, E, and F in Example 1 are exposed. With such a configuration, stress concentration on vertices can be minimized. Therefore, the configuration of Example 2 is preferable from the perspectives of maintaining the substrate strength and preventing possible breakage. This does not mean that the pitch conversion channel 1217 must be formed in the form of a tetradecahedron. The channel may be formed as any polyhedron with a configuration that minimizes stress concentration on vertices, preferably a polyhedron of at least fourteen faces.

### Twelfth Embodiment

The liquid ejection head 11 according to the twelfth embodiment differs from the ninth embodiment in the shape of the channels in the second channel substrate. The following will focus on the differences in configuration between the ninth and twelfth embodiments, omitting redundant descriptions of features that are the same or similar.

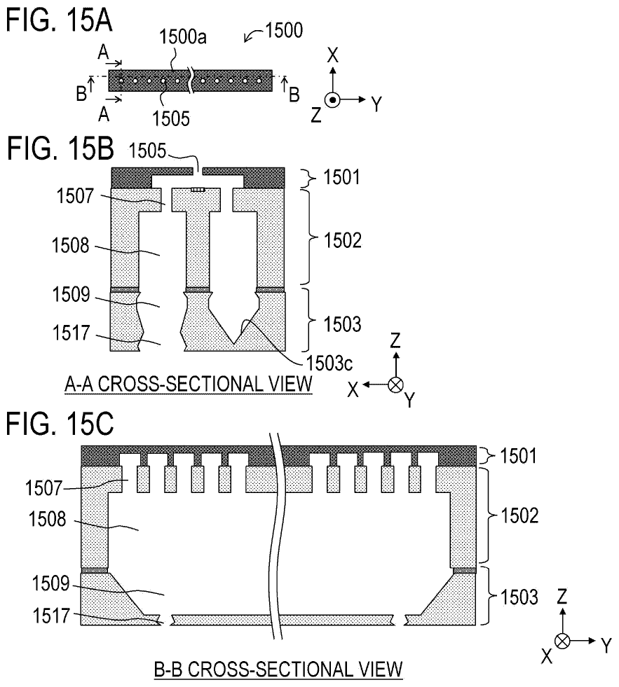

A liquid ejection substrate 1500 in the liquid ejection head 11 according to the twelfth embodiment will be described with reference to FIG. 15A through FIG. 15C. FIG. 15A is a schematic plan view of the liquid ejection surface 1500a of the liquid ejection substrate 1500 according to the twelfth embodiment as viewed in the Z direction. FIG. 15B is a schematic cross-sectional view of a cross section A-A perpendicular to the Y direction of FIG. 15A. FIG. 15C is a schematic cross-sectional view of a cross section B-B perpendicular to the X direction of FIG. 15A. FIG. 15B and FIG. 15C each show the liquid flow paths in the liquid ejection head 11.

### Configuration of Liquid Ejection Substrate in Twelfth Embodiment

The liquid ejection substrate 1500 has a laminated structure including a nozzle layer 1501, a first channel substrate 1502, and a second channel substrate 1503. The liquid flow paths in the liquid ejection substrate 1500 are formed by the nozzles 1505 in the nozzle layer 1501, individual supply ports 1507 and a first common liquid chamber 1508 in the first channel substrate 1502, and a second common liquid chamber 1509 and pitch conversion channels 1517 in the second channel substrate 1503.

In the twelfth embodiment, the second common liquid chamber 1509 has a polygonal shape with at least five sides in the cross section A-A. The cross-sectional shape in the cross section A-A at the end on the side farthest from the first common liquid chamber 1508 in the Z direction (the substrate thickness direction) has opposing sides (faces) that make an acute angle. Moreover, the cross-sectional shape in the cross section A-A includes a part that is larger in width in the X direction than the first common liquid chamber 1508 so as to increase the volume of the second common liquid chamber 1509. Namely, at the end of the second common liquid chamber 1509, the second wall portion 1503c is tapered so that the side walls are angled relative to the Z direction.

At the start of high-frequency printing, in particular, an instantaneous refill shortfall at the beginning of continuous ejection can sometimes result in a printing disturbance. This is due to an increase in the inertance of the channel, which is equivalent to the coefficient of inertia when the liquid in the channel is pushed out with a unit pressure. The inertance of a channel is proportional to the fluid density and the channel length, and is inversely proportional to the sectional area of the channel. Therefore, increasing the sectional area of the second common liquid chamber can reduce the inertance and help minimize printing disturbances. This is an issue that arises regardless of the channel configuration. In a circulatory channel configuration, the issue more likely occurs when the common liquid chamber has a reduced sectional area due to the formation of a partition wall, or when the individual supply ports are reduced in size. Therefore, the second common liquid chamber with an increased sectional area, as in the twelfth embodiment, is particularly preferable for recirculation liquid ejection heads.

The side walls of the second common liquid chamber 1509 are tapered so that the side walls facing each other at the end on the side farthest from the nozzles 1505 make an acute angle. This configuration causes air bubbles that entered the liquid chamber to more easily gather at the distal end of the second common liquid chamber 1509 far from the nozzles 1505, whereby the adverse effects of air bubbles on the ejection performance can be minimized. The air bubbles that accumulate at the distal end also function as a damper, which helps improve the ejection performance. Since the second common liquid chamber 1509 is partly in communication with the pitch conversion channels 1517 in the longitudinal direction (Y direction), the air bubbles that have gathered are released through the pitch conversion channels 1517 to the outside of the liquid ejection substrate 1500.

While FIG. 15B shows an example in which the second common liquid chamber 1509 has an octagonal cross-sectional shape including the planes with openings, the configuration is not limited to this example. The sectional shape may be any polygon other than an octagon. The cross-sectional shapes of the second common liquid chamber 1509 and the pitch conversion channels 1517 are not limited to strict polygonal shapes formed by straight lines alone, but may include curves resulting from the forming method.

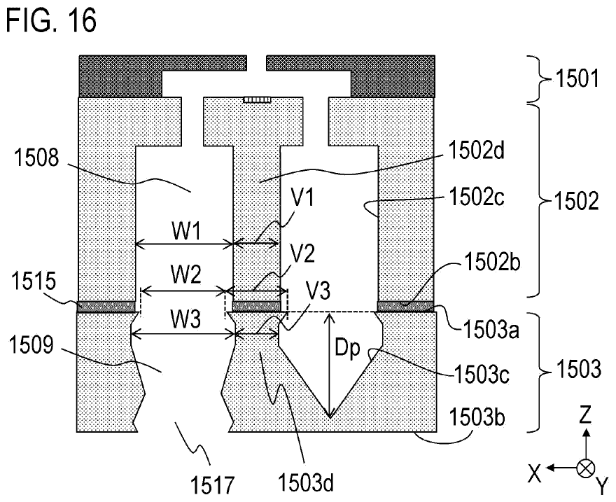

Referring to FIG. 16, the relationship between the first common liquid chamber 1508 and the second common liquid chamber 1509 will be described in more detail. FIG. 16 is an illustrative diagram showing the relationship between the first common liquid chamber 1508 and the second common liquid chamber 1509. It is a schematic cross-sectional view of a cross section A-A perpendicular to the Y direction of FIG. 15A.

The first channel substrate 1502 includes a first wall portion 1502c that includes a first partition wall 1502d separating two first common liquid chambers 1508 adjacent in the X direction. The first partition wall 1502d is columnar, extending straight in the Z direction, with a width V1 in the X direction constant along the Z direction. The opening width W1 of the first common liquid chamber 1508 in the X direction is also constant along the Z direction.

The second channel substrate 1503 includes a second wall portion 1503c that includes a second partition wall 1503d separating two second common liquid chambers 1509 adjacent in the X direction. The second partition wall 1503d is columnar, with its width in the X direction varying along the Z direction. The second partition wall 1503d has a width V2 in the X direction that is greater than V1, at the end that includes the third surface 1503a, which is the surface bonded to the first channel substrate 1502. Namely, in the joint portion between the first channel substrate 1502 and the second channel substrate 1503, the width V1 of the first partition wall 1502d is smaller than the width V2 of the second partition wall 1503d. The width in the X direction of the second partition wall 1503d reduces gradually as it extends away from the first channel substrate 1502 (from the third surface 1503a toward the fourth surface 1503b) until it is V3 smaller than V1. The width V3 is the minimum width of the second partition wall 1503d. The second partition wall 1503d includes vertical walls extending straight in the Z direction with the width V3. The width in the X direction of the second partition wall 1503d then gradually increases from V3 as it extends away from the first channel substrate 1502. Namely, the second partition wall 1503d includes a constricted portion having a width V3.

The second common liquid chamber 1509 has an opening width W2 in the X direction that is smaller than the opening width W1 at the end with the third surface 1503a. Namely, in the joint portion between the first common liquid chamber 1508 and the second common liquid chamber 1509, the opening width W2 of the second common liquid chamber 1509 is smaller than the opening width W1 of the first common liquid chamber 1508. The opening width in the X direction of the second common liquid chamber 1509 then gradually increases as it extends away from the first common liquid chamber 1508 (first channel substrate 1502) until it is W3 that is greater than W1. The opening width W3 is the maximum opening width of the second common liquid chamber 1509. The opening width in the X direction of the second common liquid chamber 1509 then gradually decreases from W3 as it extends away from the first common liquid chamber 1508.

As described above, in the twelfth embodiment, the width W1 of the first common liquid chamber 1508 is set greater than the width W2 of the second common liquid chamber 1509. The width V2 of the second partition wall 1503d on the bonded side is set greater than the width V1 of the first partition wall 1502d. This configuration ensures that the first channel substrate 1502 and the second channel substrate 1503 are bonded together with a sufficient bonding area even if the substrates are displaced from their ideal positions, and allows the bonding strength to be maintained. Since the second partition wall 1503d has a greater width V2 than the width V1 of the first partition wall 1502d, the third surface 1503a of the second channel substrate 1503 has a greater area than that of the second surface 1502b of the first channel substrate 1502. This configuration prevents the adhesive 1515 applied to join the substrates together from being squeezed out onto the second channel substrate 1503. To achieve this effect, the second partition wall 1503d should preferably have a width V2 that is greater than the width V1 of the first partition wall 1502d by at least 10 μm.

Increasing the opening width W3 of the second common liquid chamber 1509 in the X direction to increase its sectional area or volume reduces the width V3 of the constricted portion of the second partition wall 1503d. To avoid the risk of breakage that may be caused by the width V3 being too small, the constricted portion of the second partition wall 1503 d should preferably have a width V3 of at least 15 μm.

The maximum depth Dp of the second common liquid chamber 1509 should preferably be at least half the thickness (width in the Z direction) of the second channel substrate 1503 so as to increase the volume of the second common liquid chamber 1509.

According to the configuration of the twelfth embodiment, the volume of the second common liquid chamber 1509 can be increased while maintaining the bonding strength and suppressing adhesive creep. This configuration can thus improve the performance of the liquid ejection head by enabling more efficient liquid replenishment to the nozzles and by preventing crosstalk between adjacent nozzles.

### Thirteenth Embodiment

The liquid ejection head 11 according to the thirteenth embodiment differs from the twelfth embodiment in the configuration of the second channel substrate. The following will focus on the differences in configuration between the twelfth and thirteenth embodiments, omitting redundant descriptions of features that are the same or similar.

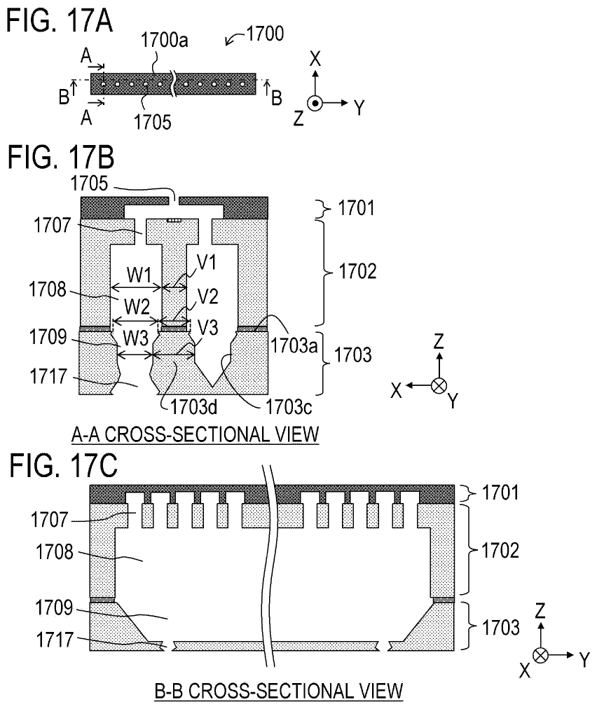

A liquid ejection substrate 1700 in the liquid ejection head 11 according to the thirteenth embodiment will be described with reference to FIG. 17A through FIG. 17C. FIG. 17A is a schematic plan view of the liquid ejection surface 1700a of the liquid ejection substrate 1700 according to the thirteenth embodiment as viewed in the Z direction. FIG. 17B is a schematic cross-sectional view of a cross section A-A perpendicular to the Y direction of FIG. 17A. FIG. 17C is a schematic cross-sectional view of a cross section B-B perpendicular to the X direction of FIG. 17A. FIG. 17B and FIG. 17C each show the liquid flow paths in the liquid ejection head 11.

### Configuration of Liquid Ejection Substrate in Thirteenth Embodiment

The liquid ejection substrate 1700 has a laminated structure including a nozzle layer 1701, a first channel substrate 1702, and a second channel substrate 1703. The liquid flow paths in the liquid ejection substrate 1700 are formed by the nozzles 1705 in the nozzle layer 1701, individual supply ports 1707 and a first common liquid chamber 1708 in the first channel substrate 1702, and a second common liquid chamber 1709 and pitch conversion channels 1717 in the second channel substrate 1703.

The second partition wall 1703d, which is a part of the second wall portion 1703c, has a width V2 in the X direction that is greater than V1, at the end that includes the third surface 1703a, which is the surface bonded to the first channel substrate 1702. The width in the X direction of the second partition wall 1703d first decreases and then increases gradually as it extends away from the first channel substrate 1702 until it is V3 that is greater than V1 and V2. The second partition wall 1703d includes vertical walls extending straight in the Z direction with the width V3. The width in the X direction of the second partition wall 1703d then gradually increases from V3 as it extends away from the first channel substrate 1702.

The second common liquid chamber 1709 has an opening width W2 in the X direction that is smaller than the opening width W1 at the end with the third surface 1703a. The opening width in the X direction of the second common liquid chamber 1709 first increases and then decreases gradually as it extends away from the first common liquid chamber 1708 (first channel substrate 1702) until it is W3 that is smaller than W1 and W2. The opening width in the X direction of the second common liquid chamber 1709 then gradually decreases from W3 as it extends away from the first common liquid chamber 1708.

Increasing the width V3 of the second partition wall 1703d in this manner enhances the mechanical strength of the partition wall. Therefore, the configuration of the thirteenth embodiment is suitable for chip shrink, i.e., when it is desired to reduce the physical size of the second channel substrate or the liquid ejection substrate.

### Fourteenth Embodiment

The liquid ejection head 11 according to the fourteenth embodiment differs from the twelfth embodiment in the configuration of the second channel substrate. The following will focus on the differences in configuration between the twelfth and fourteenth embodiments, omitting redundant descriptions of features that are the same or similar.

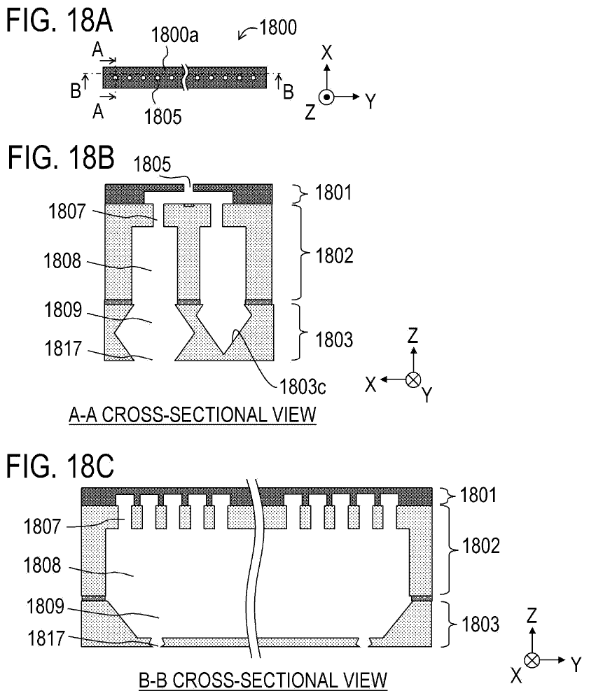

A liquid ejection substrate 1800 in the liquid ejection head 11 according to the fourteenth embodiment will be described with reference to FIG. 18A through FIG. 18C. FIG. 18A is a schematic plan view of the liquid ejection surface 1800a of the liquid ejection substrate 1800 according to the fourteenth embodiment as viewed in the Z direction. FIG. 18B is a schematic cross-sectional view of a cross section A-A perpendicular to the Y direction of FIG. 18A. FIG. 18C is a schematic cross-sectional view of a cross section B-B perpendicular to the X direction of FIG. 18A. FIG. 18B and FIG. 18C each show the liquid flow paths in the liquid ejection head 11.

### Configuration of Liquid Ejection Substrate in Fourteenth Embodiment

The liquid ejection substrate 1800 has a laminated structure including a nozzle layer 1801, a first channel substrate 1802, and a second channel substrate 1803. The liquid flow paths in the liquid ejection substrate 1800 are formed by the nozzles 1805 in the nozzle layer 1801, individual supply ports 1807 and a first common liquid chamber 1808 in the first channel substrate 1802, and a second common liquid chamber 1809 and pitch conversion channels 1817 in the second channel substrate 1803.

The second wall portion 1803c, which forms the second common liquid chamber 1809 and the pitch conversion channels 1817, according to the fourteenth embodiment, is a tapered surface formed by the exposed <111> plane of silicon. In other words, the side walls forming the second common liquid chamber 1809 and the pitch conversion channels 1817 are exposed <111> planes and inclined relative to the Z direction. The maximum width in the X direction of the second common liquid chamber 1809 is set larger than that of the first common liquid chamber 1808. This configuration increases the sectional area of the second common liquid chamber 1809 and helps minimize printing disturbances. Moreover, since the channel configuration is determined by the crystal orientation of the silicon that forms the substrates, the second common liquid chamber and pitch conversion channels can be fabricated with favorable machining precision.

The <111> plane shows high insolubility to ink. Therefore, exposing the <111> plane eliminates the need for a silicon protection film that prevents silicon from being dissolved in the ink. This enables fabrication of a reliable liquid ejection head.

The configurations of the embodiments described above may be combined as needed. For example, protruded portions similar to those of the fourth embodiment may be provided in the configuration of the third embodiment. A filter similar to that of the sixth embodiment may be provided, for example, in the configuration of the fifth embodiment.

### Example 1

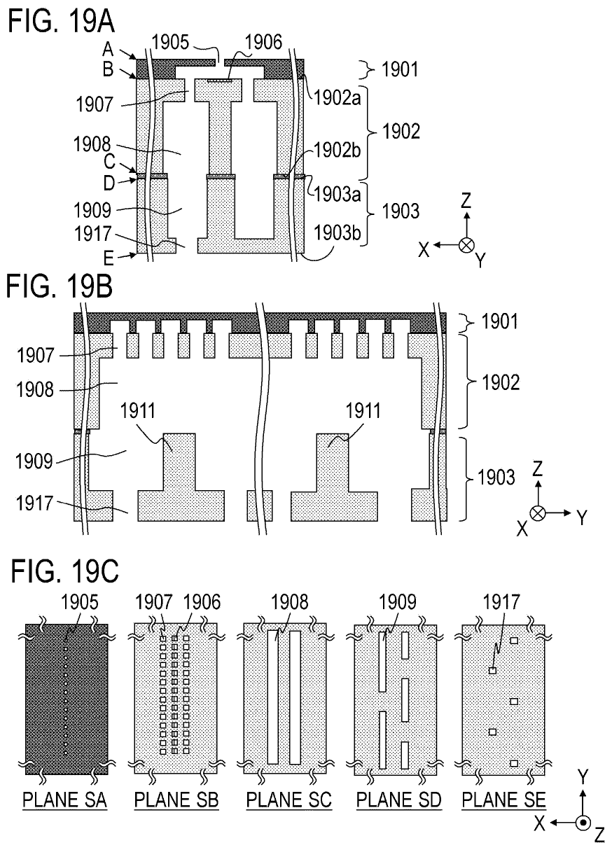

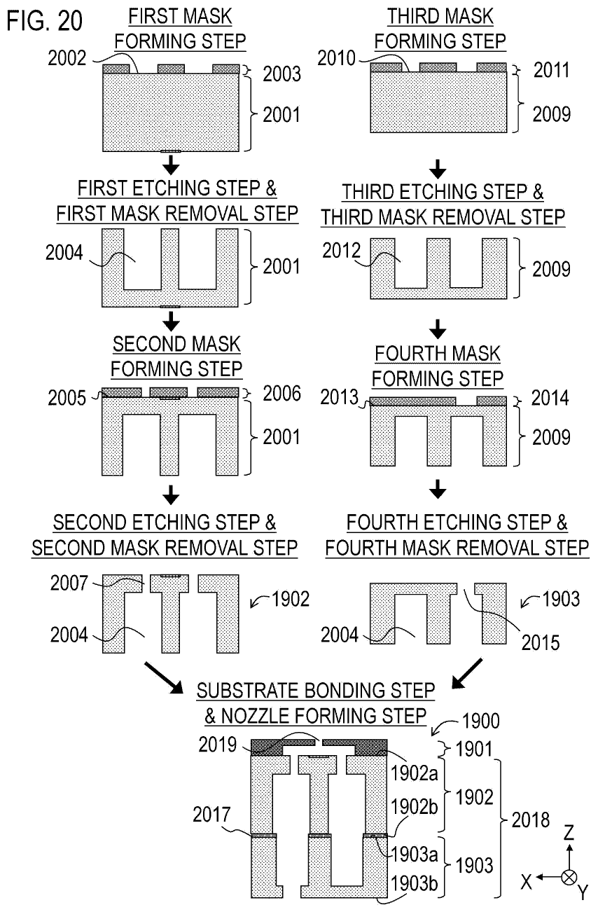

An illustrative description of specific examples of the method for fabricating the liquid ejection substrate is provided below. First, Example 1 will be described with reference to FIG. 19A through FIG. 19C and FIG. 20. The following will focus on the differences in configuration between Example 1 and the seventh embodiment, omitting redundant descriptions of features that are the same or similar.

FIG. 19A is a schematic cross-sectional view of the liquid ejection substrate 1900 according to Example 1 as viewed in a cross section perpendicular to the Y direction. FIG. 19B is a schematic cross-sectional view of the liquid ejection substrate 1900 as viewed in a cross section perpendicular to the X direction. FIG. 19C is a schematic cross-sectional view of the liquid ejection substrate 1900 as viewed in cross sections shown in FIG. 19A. FIG. 19A to FIG. 19C show only a part of the liquid ejection substrate 1900 for simplicity.

The liquid ejection substrate 1900 has a laminated structure including a nozzle layer 1901, a first channel substrate 1902, and a second channel substrate 1903. The liquid flow paths in the liquid ejection substrate 1900 are formed by the nozzles 1905 in the nozzle layer 1901, individual supply ports 1907 and a first common liquid chamber 1908 in the first channel substrate 1902, and a second common liquid chamber 1909 and pitch conversion channels 1919 in the second channel substrate 1903. A thermoelectric module 1906 is provided on the first channel substrate 1902. The second common liquid chamber 1909 is provided with a plurality of protruded portions 1911 therein that project from the bottom surface of the second channel substrate 1903 toward the first common liquid chamber 1908 in the Z direction.

Plane SA shown in FIG. 19C is a nozzle-forming surface on which the nozzles 1905 of the nozzle layer 1901 open. Plane SB is a first surface 1902a on which the individual supply ports 1907 of the first channel substrate 1902 open. Plane SC is a second surface 1902b on which the first common liquid chamber 1908 of the first channel substrate 1902 opens. Plane SD is a third surface 1903a on which the second common liquid chamber 1909 of the second channel substrate 1903 opens. Plane SE is a fourth surface 1903b on which the pitch conversion channels 1919 of the second channel substrate 1903 open.

FIG. 20 is an illustrative diagram of a fabrication method of the liquid ejection substrate 1900 according to Example 1. The method for fabricating the liquid ejection substrate 1900 will be described with reference to FIG. 20. First, a fabrication method of the first channel substrate 1902 is described. The first channel substrate 1902 used here was a 625 μm-thick silicon substrate 2001 with a thermoelectric module 1906.

First, as a first mask forming step, a photoresist was applied to a thickness of 15 μm on the surface 2002 on the side of the silicon substrate 2001 opposite the thermoelectric module 1906 (surface that will become the second surface 1902b of the first channel substrate 1902). The photoresist was developed by irradiating it with UV light to form a photoresist mask 2003. The photoresist mask 2003 for forming the first common liquid chamber 1908 had a mask pattern (hole pattern) with rectangular openings measuring 20,000 μm long in the Y direction and 200 μm long in the X direction, with a 200 μm pitch between the common liquid chambers.

Next, as a first etching step, dry etching was performed, in which a protective film was formed using a C₄F₈ gas and silicon was etched using a SF₆ gas alternately. The silicon was etched to a depth of 500 μm from the surface 2002 of the substrate 2001 via the photoresist mask 2003. Next, as a first mask removal step, ashing was performed using O₂ to remove the photoresist mask 2003. A space 2004 that will become the first common liquid chamber 1908 is thus formed in the silicon substrate 2001 through the first mask forming step, first etching step, and first mask removal step. These first mask forming step, first etching step, and first mask removal step shall be collectively referred to as a first channel forming step (first common liquid chamber forming step).

Next, as a second mask forming step, a photoresist was applied to a thickness of 15 μm on the surface 2005 of the silicon substrate 2001 where the thermoelectric module 1906 is provided (surface that will become the first surface 1902a of the first channel substrate 1902). The photoresist was developed by irradiating it with UV light to form a photoresist mask 2006. The photoresist mask 2006 for forming the individual supply ports 1907 had a mask pattern with square openings measuring 50 μm long in the Y direction and 50 μm long in the X direction, with a 50 μm pitch between the individual supply ports.

Next, as a second etching step, the silicon was etched from the surface 2005 of the substrate 2001 via the photoresist mask 2006 by dry etching similar to the first etching step through to the space 2004. After that, as a second mask removal step, the photoresist mask 2006 was removed similarly to the first mask removal step. A space 2007 that will become the second common liquid chamber 1909 is thus formed in the silicon substrate 2001 through the second mask forming step, second etching step, and second mask removal step. These second mask forming step, second etching step, and second mask removal step shall be collectively referred to as a second channel forming step (individual supply port forming step). In this example, the individual supply ports 1907 are 125 μm deep.

The first channel substrate 1902 is obtained by the above-described first channel forming step and second channel forming step. The first common liquid chamber 1908 has a depth (length in the Z direction) of 500 μm, and the individual supply ports 1907 have a depth of 125 μm in the first channel substrate 1902.

A fabrication method of the second channel substrate 1903 is described. A 400 μm-thick silicon substrate 2009 was used for the second channel substrate 1903.

First, as a third mask forming step, a photoresist was applied to a thickness of 15 μm on the surface 2010 of the silicon substrate 2009 (surface that will become the third surface 1903a of the second channel substrate 1903). The photoresist was developed by irradiating it with UV light to form a photoresist mask 2011. The photoresist mask 2011 for forming the second common liquid chamber 1909 had a mask pattern with rectangular openings measuring 21,000 μm long in the Y direction and 190 μm long in the X direction. The mask pattern also included a part in a middle area (between one end to the other in the Y direction) for forming protruded portions 1911 that are 3,000 μm wide in the Y direction and 190 μm wide in the X direction. The pitch between the common liquid chambers in the X direction was set to 200 μm.

Next, as a third etching step, dry etching was performed in which a protective film was formed using a C₄F₈ gas and silicon was etched using a SF₆ gas alternately. The silicon was etched to a depth of 300 μm from the surface 2010 of the silicon substrate 2009 via the photoresist mask 2011. Next, as a third mask removal step, ashing was performed using O₂ to remove the photoresist mask 2011. A space 2012 that will become the second common liquid chamber 1909 is thus formed in the silicon substrate 2009 through the third mask forming step, third etching step, and third mask removal step. These third mask forming step, third etching step, and third mask removal step shall be collectively referred to as a third channel forming step (second common liquid chamber forming step).

Next, as a fourth mask forming step, a photoresist was applied to a thickness of 15 μm on the surface 2013 on the opposite side of the silicon substrate 2009 from the surface 2010 (surface that will become the fourth surface 1903b of the second channel substrate 1903). The photoresist was developed by irradiating it with UV light to form a photoresist mask 2014. The photoresist mask 2014 for forming the pitch conversion channels 1917 had a mask pattern with square openings measuring 170 μm long in the Y direction and 170 μm long in the X direction, with a 9,000 μm pitch between the pitch conversion channels in the Y direction.

Next, as a fourth etching step, the silicon was etched from the surface 2013 of the substrate 2009 via the photoresist mask 2014 by dry etching similar to the third etching step through to the space 2012. After that, as a fourth mask removal step, the photoresist mask 2014 was removed similarly to the third mask removal step. A space 2015 that will become the pitch conversion channel 1917 is thus formed in the silicon substrate 2009 through the fourth mask forming step, fourth etching step, and fourth mask removal step. These fourth mask forming step, fourth etching step, and fourth mask removal step shall be collectively referred to as a fourth channel forming step (pitch conversion channel forming step). In this example, the pitch conversion channels 1917 are 100 μm deep.

The second channel substrate 1903 is obtained by the above-described third channel forming step and fourth channel forming step. The second common liquid chamber 1909 has a depth (length in the Z direction) of 300 μm, and the pitch conversion channels 1917 have a depth of 100 μm in the second channel substrate 1903.

Next, as a substrate bonding step, the surface 2002 (the second surface 1902b) of the first channel substrate 1902 and the surface 2013 (the third surface 1903a) of the second channel substrate 1903 were bonded together using an epoxy resin adhesive 2017 by applying heat and pressure. The channel substrate 2018, which is the first channel substrate 1902 and the second channel substrate 1903 bonded together, is obtained by this substrate bonding step.

Lastly, as a nozzle forming step, a photosensitive epoxy resin film was laminated on the surface 2005 (first surface 1902a) of the first channel substrate 1902, which was then exposed and developed. The nozzle layer 1901 including the liquid ejection ports 2019 (nozzles 1905) is formed by the nozzle forming step, whereby the liquid ejection substrate 1900 is complete. The common liquid chamber of the resultant liquid ejection substrate 1900 is 800 μm deep, which is the sum of the depth 500 μm of the first common liquid chamber 1908 and the depth 300 μm of the second common liquid chamber 1909.

The liquid ejection substrate in which the common liquid chamber is formed by the first common liquid chamber of the first channel substrate and the second common liquid chamber of the second channel substrate is thus obtained through the fabrication method described above. This fabrication method thus allows for the production of liquid ejection substrates with features that enable more efficient liquid replenishment to the nozzles and prevent crosstalk between adjacent nozzles. To achieve the intended effects, the common liquid chamber should preferably have a depth of at least 600 μm to increase its volume. The method also allows a protruded portion 1911 to be formed inside the second common liquid chamber, which reduces liquid flow stagnation and helps prevent bubble accumulation and solute adhesion.

### Example 2

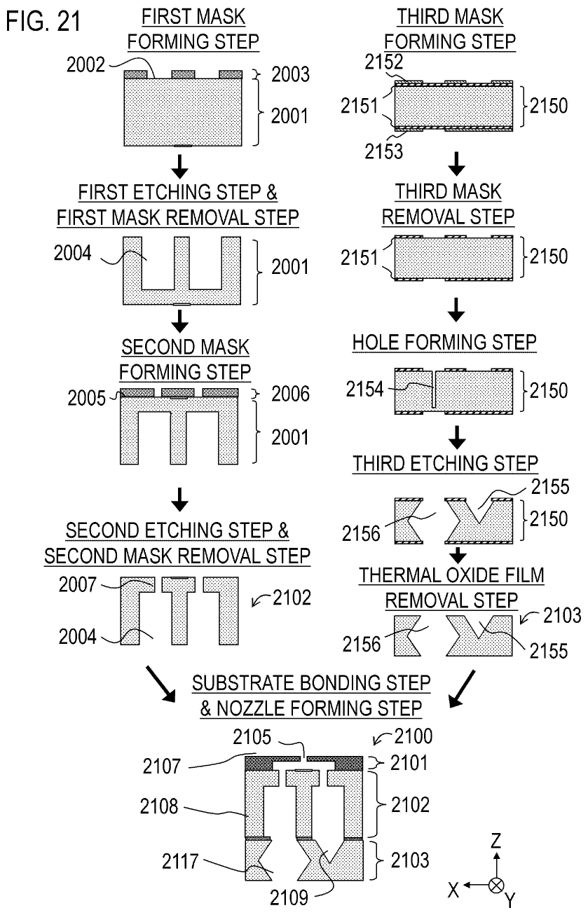

Example 2 will be described with reference to FIG. 21. Example 2 is different from Example 1 in that the second common liquid chamber and the pitch conversion channels are formed by wet etching instead of dry etching. The following will focus on the differences between Example 1 and Example 2 of the fabrication method of the liquid ejection substrate, omitting redundant descriptions of features that are the same or similar.

The liquid ejection substrate 2100 according to Example 2 has a laminated structure including a nozzle layer 2101, a first channel substrate 2102, and a second channel substrate 2103. The liquid flow paths in the liquid ejection substrate 2100 are formed by the nozzles 2105 in the nozzle layer 2101, individual supply ports 2107 and a first common liquid chamber 2108 in the first channel substrate 2102, and a second common liquid chamber 2109 and pitch conversion channels 2117 in the second channel substrate 2103.

FIG. 21 is an illustrative diagram of a fabrication method of the liquid ejection substrate 2100 according to Example 2. The method for fabricating the liquid ejection substrate 2100 will be described with reference to FIG. 21. The channel configuration in Example 2 is similar to that of the eleventh embodiment shown in FIG. 12A to FIG. 12C.

In Example 2, the first channel substrate 2102 is formed similarly to Example 1. Hereinafter, a method for fabricating the second channel substrate 2103 according to Example 2 will be described. A 400 μm-thick silicon substrate 2150 was used for the second channel substrate 2103. The silicon substrate 2150 is formed with a 500 nm-thick thermal oxide film 2151 on its surface.

First, as a third mask forming step, a photoresist was applied to a thickness of 15 μm on both sides of the silicon substrate 2150. The photoresist was developed by irradiating it with UV light to form a photoresist mask 2152 on one side for the second common liquid chamber, and a photoresist mask 2153 on the other side for the pitch conversion channels (connecting channel). The mask pattern for the second common liquid chamber had rectangular openings measuring 2,000 μm long in the Y direction and 200 μm long in the X direction. The mask pattern for the pitch conversion channels had rectangular openings measuring 1,000 μm long in the Y direction and 200 μm long in the X direction.

Next, as a first patterning step, the thermal oxide film was patterned by wet etching, using buffered hydrofluoric acid, for a predetermined time until the silicon was exposed. As a third mask removal step, the photoresist masks 2152 and 2153 were removed by a wet treatment using a resist stripper.

Next, as a hole forming step, leading holes 2154 were formed in the mask pattern (hole pattern) for the pitch conversion channels on the surface of the second channel substrate 2103 on which the second common liquid chamber 2109 opens. The leading holes 2154 have their depth direction matched with the Z direction. The leading holes 2154 were formed using a laser so that they would penetrate the silicon during the wet etching to form the pitch conversion channels. The number of shots was adjusted in the machining to form the leading holes 2154 at 100 μm pitch intervals to a depth of 350 μm.

Next, as a third etching step, the silicon substrate 2150 was immersed in an aqueous solution of tetramethylammonium hydroxide (85° C., 20 wt %) for 300 minutes to carry out crystalline anisotropic etching. This etching process forms a space 2155 and a space 2156 inside the silicon substrate 2150, which will become the second common liquid chamber 2109 and the pitch conversion channel 2117, respectively. The side walls of the space 2155 and the space 2156 in this step are tapered at an angle of 54.7°. The processing time in this example is the time it takes to form the pitch conversion channels 2117 in the form of a tetradecahedron.

Next, as a thermal oxide film removal step, the thermal oxide film 2151, made overhanging due to undercutting of the silicon hole pattern by crystalline anisotropic etching, is removed by immersion in buffered hydrofluoric acid. The thermal oxide film may be entirely removed in this step. These third mask forming step, third mask removal step, hole forming step, third etching step, and thermal oxide film removal step shall be collectively referred to as a third channel forming step (second common liquid chamber and pitch conversion channel forming step).

The second channel substrate 2103 is obtained by the above-described third channel forming step. The subsequent substrate bonding step and the nozzle forming step are the same as those of Example 1.

A liquid ejection substrate that enables more efficient liquid replenishment to the nozzles and prevents crosstalk between adjacent nozzles is obtained through the formation of the second common liquid chamber by the above fabrication method. In the liquid ejection substrate thus fabricated, the side walls forming the channels in the second channel substrate include a plurality of inclined (tapered) surfaces, which help reduce stagnation of the liquid flow, and prevent bubble accumulation and solute adhesion.

### Example 3

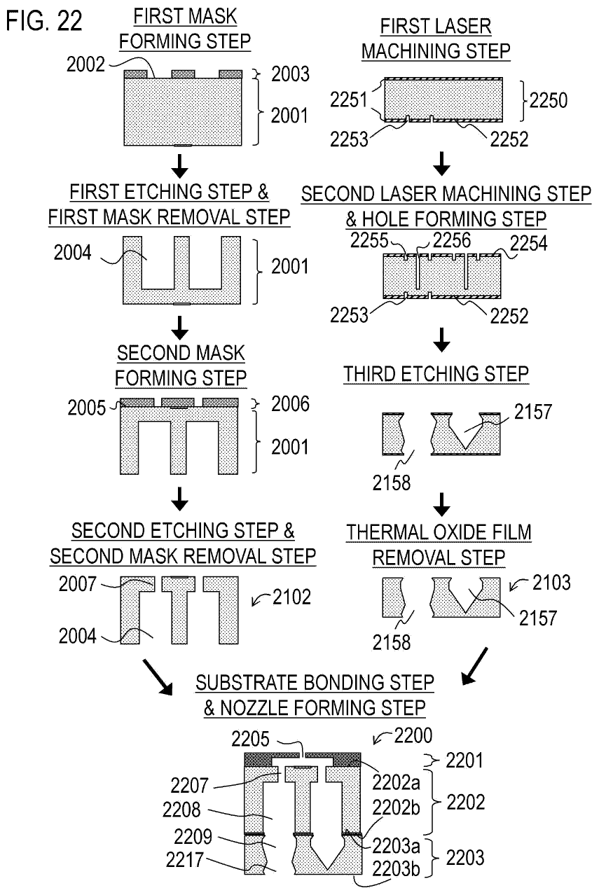

Example 3 will be described with reference to FIG. 22. Example 3 is different from Example 2 in that the second common liquid chamber and the pitch conversion channels are formed by wet etching and laser. The following will focus on the differences between Example 2 and Example 3 of the fabrication method of the liquid ejection substrate, omitting redundant descriptions of features that are the same or similar.

The liquid ejection substrate 2200 according to Example 3 has a laminated structure including a nozzle layer 2201, a first channel substrate 2202, and a second channel substrate 2203. The liquid flow paths in the liquid ejection substrate 2200 are formed by the nozzles 2205 in the nozzle layer 2201, individual supply ports 2207 and a first common liquid chamber 2208 in the first channel substrate 2202, and a second common liquid chamber 2209 and pitch conversion channels 2217 in the second channel substrate 2203.

FIG. 22 is an illustrative diagram of a fabrication method of the liquid ejection substrate 2200 according to Example 3. The method for fabricating the liquid ejection substrate 2200 will be described with reference to FIG. 22. The channel configuration in Example 3 is similar to that of the twelfth embodiment shown in FIG. 15A to FIG. 15C.

In Example 3, the first channel substrate 2202 is formed similarly to Example 1 and Example 2. Hereinafter, a method for fabricating the second channel substrate 2203 according to Example 3 will be described. A 400 μm-thick silicon substrate 2250 was used for the second channel substrate 2203. The silicon substrate 2250 is formed with a 500 nm-thick thermal oxide film 2251 on its surface.

As a first laser machining step, openings 2253 for the pitch conversion channels 2217 were formed using laser on one surface 2252 of the silicon substrate 2250 having the <100> crystal plane orientation (the surface that will become the fourth surface 2203b of the second channel substrate 2203). To form frame-like openings 2253, linear machining was performed. This hole patterning step is performed so that the openings 2253 will become pitch conversion channels 2217 and communicate with the second common liquid chamber 2209 by wet etching in a later step. Therefore, no openings are formed in areas where there are no pitch conversion channels 2217. The frequency and the moving speed of the laser were adjusted in the linear machining to form grooves to a depth of 20 μm in the thermal oxide film and silicon. The hole pattern for the pitch conversion channels 2217 had rectangular openings measuring 1,000 μm long in the Y direction and 160 μm long in the X direction.

Next, as a second laser machining step, openings 2255 for the second common liquid chamber 2209 were formed using a laser on the surface 2254 on the opposite side of the silicon substrate 2250 from the surface 2252 (the surface that will become the third surface 2203a of the second channel substrate 2203). Similarly to the first laser machining step, the hole pattern was formed by linear machining. The hole pattern for the second common liquid chamber 2209 had rectangular openings measuring 30,000 μm long in the Y direction and 160 μm long in the X direction. The hole patterns for the second common liquid chamber 2209 and the pitch conversion channels 2217 may also be formed by patterning a resist using photolithography and by etching the thermal oxide film, similarly to Example 2. The grooves can also be formed by dry etching.

Next, as a hole forming step (third laser machining step), leading holes 2256 were formed by laser in the pattern for the second common liquid chamber 2209 so that the pitch conversion channels 2217 will extend through the silicon in the wet etching step. The leading holes 2256 have their depth direction matched with the Z direction. The number of shots was adjusted in the machining to form the leading holes 2256 at 100 μm pitch intervals to a depth of 300 μm. In this example, the hole pattern (openings 2255) for the second common liquid chamber 2209 and the leading holes 2256 were first aligned and registered with the hole pattern (openings 2253) for the previously machined pitch conversion channels 2217 before the laser machining. The leading holes 2256 may also be formed by patterning using photolithography and dry etching.

Next, as a third etching step, the silicon substrate 2250 was immersed in an aqueous solution of tetramethylammonium hydroxide (85° C., 20 wt %) for 90 minutes to carry out crystalline anisotropic etching. By the third etching step, a space 2257 and a space 2258 were formed inside the silicon substrate 2250, which will become the second common liquid chamber 2209 and the pitch conversion channels 2217, respectively. The processing time in this example is the time it takes to form the second common liquid chamber 2209 with a septagonal internal shape with a larger opening width than that on the surface on which it opens. By shortening the immersion time to 45 minutes, for example, the second common liquid chamber and the pitch conversion channels according to the thirteenth embodiment shown in FIG. 17B and FIG. 17C can be formed. Conversely, by prolonging the immersion time to 420 minutes, for example, the second common liquid chamber and the pitch conversion channels according to the fourteenth embodiment shown in FIG. 18B and FIG. 18C in which the <111> plane is exposed on the entire side walls can be formed.

An alternative to linear machining with a laser and wet etching for forming pitch conversion channels is to use photolithography to form a hole pattern and then etch through the substrate using dry etching.

Next, as a thermal oxide film removal step, the thermal oxide film 2251, made overhanging due to undercutting of the silicon hole pattern by crystalline anisotropic etching, is removed by immersion in buffered hydrofluoric acid. The thermal oxide film may be entirely removed in this step. After forming the pitch conversion channels and the second common liquid chamber, a silicon protection film may be formed to prevent the silicon exposed inside the liquid flow paths in the second channel substrate from being dissolved in the ink. These first laser machining step, second laser machining step, hole forming step, third etching step, and thermal oxide film removal step shall be collectively referred to as a third channel forming step (second common liquid chamber and pitch conversion channel forming step).

The second channel substrate 2203 is obtained by the above-described third channel forming step. The subsequent substrate bonding step and the nozzle forming step are the same as those of Example 1.

A liquid ejection substrate that enables more efficient liquid replenishment to the nozzles and prevents crosstalk between adjacent nozzles is obtained through the formation of the second common liquid chamber by the above fabrication method. In the liquid ejection substrate thus fabricated, the side walls forming the channels in the second channel substrate include a plurality of inclined (tapered) surfaces, so that air bubbles will be trapped at the distal end far from the nozzles and discharged from the pitch conversion channels.

According to the present disclosure, a liquid ejection substrate having a common liquid chamber configured for better performance can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-218131, filed Dec. 12, 2024, which is hereby incorporated by reference herein in its entirety.

What is claimed is:

1. A liquid ejection substrate for use in a liquid ejection head, having an internal liquid flow path including a nozzle, an individual channel communicating with the nozzle, and a common liquid chamber communicating with the individual channel, the liquid ejection substrate comprising:
a nozzle forming member having a liquid ejection surface on which the nozzle opens;
a first channel substrate including a first surface on which the nozzle forming member is provided, a second surface on an opposite side from the first surface, and a first wall portion forming a wall portion of the individual channel and the common liquid chamber; and
a second channel substrate including a third surface that is joined to the second surface of the first channel substrate in a first direction and a second wall portion forming a wall portion of the common liquid chamber,
wherein the second wall portion includes a part where a cross section perpendicular to the first direction has a different sectional area from a sectional area of the first wall portion.

2. The liquid ejection substrate according to claim 1,
wherein the common liquid chamber includes a first common liquid chamber, which is a part formed by the first wall portion, and a second common liquid chamber, which is a part formed by the second wall portion and connected to the first common liquid chamber,
the first common liquid chamber and the second common liquid chamber having different sectional areas in a cross section perpendicular to the first direction in a joint portion between the first common liquid chamber and the second common liquid chamber.

3. The liquid ejection substrate according to claim 1,
wherein at least one of the first wall portion and the second wall portion includes a tapered surface that is inclined relative to the first direction.

4. The liquid ejection substrate according to claim 1,
wherein the common liquid chamber includes a first common liquid chamber, which is a part formed by the first wall portion, and a second common liquid chamber, which is a part formed by the second wall portion and connected to the first common liquid chamber,
the second common liquid chamber including a protruded portion formed therein, projecting from a surface facing the same direction as the third surface toward the first channel substrate in the first direction.

5. The liquid ejection substrate according to claim 1,
wherein the second channel substrate includes a fourth surface on an opposite side from the third surface, and
wherein the liquid ejection substrate further comprises a third channel substrate that includes a fifth surface joined to the fourth surface of the second channel substrate, and a third wall portion forming a wall portion of the common liquid chamber.

6. The liquid ejection substrate according to claim 1,
wherein the common liquid chamber includes a first common liquid chamber, which is a part formed by the first wall portion, and a second common liquid chamber, which is a part formed by the second wall portion and connected to the first common liquid chamber,
the liquid ejection substrate further comprising a filter provided in a joint portion between the first common liquid chamber and the second common liquid chamber.

7. The liquid ejection substrate according to claim 1,
wherein the liquid flow path further comprises a connecting channel in communication with the common liquid chamber, and
wherein the liquid ejection substrate further comprises a connecting channel forming member connected to a fourth surface on an opposite side of the second channel substrate from the third surface, and formed with the connecting channel inside.

8. The liquid ejection substrate according to claim 1,
wherein the liquid flow path further comprises a connecting channel in communication with the common liquid chamber, the second wall portion forming a wall portion of the connecting channel.

9. The liquid ejection substrate according to claim 8,
wherein the wall portion of the connecting channel, formed by the second wall portion, includes a tapered surface inclined relative to the first direction.

10. The liquid ejection substrate according to claim 8,
wherein the common liquid chamber includes a first common liquid chamber, which is a part formed by the first wall portion, and a second common liquid chamber, which is a part formed by the second wall portion and connected to the first common liquid chamber,
the connecting channel and the second common liquid chamber being not directly connected and formed independently of each other.

11. The liquid ejection substrate according to claim 10,
wherein
the second wall portion forms a plurality of the second common liquid chambers arranged in a second direction, which is defined as a longitudinal direction of the common liquid chamber as viewed in the first direction, the second common liquid chambers having an opening width in the second direction of not more than 2 mm.

12. The liquid ejection substrate according to claim 8,
wherein the connecting channel is a space of a polyhedron shape having at least fourteen faces.

13. The liquid ejection substrate according to claim 1,
wherein the common liquid chamber includes a first common liquid chamber, which is a part formed by the first wall portion, and a second common liquid chamber, which is a part formed by the second wall portion and connected to the first common liquid chamber, the common liquid chamber as viewed in the first direction having a longitudinal direction defined as a second direction, and a transverse direction perpendicular to the second direction defined as a third direction,
the second common liquid chamber having a polygonal cross-sectional shape of at least five sides in a cross section perpendicular to the third direction, the cross-sectional shape having opposing sides that make an acute angle at one end on a side far from the first common liquid chamber.

14. The liquid ejection substrate according to claim 1,
wherein the common liquid chamber includes a first common liquid chamber, which is a part formed by the first wall portion, and a second common liquid chamber, which is a part formed by the second wall portion and connected to the first common liquid chamber,
the second common liquid chamber having a length in the first direction that is at least half a width in the first direction of the second channel substrate.

15. The liquid ejection substrate according to claim 1,
wherein the common liquid chamber includes a first common liquid chamber, which is a part formed by the first wall portion, and a second common liquid chamber, which is a part formed by the second wall portion and connected to the first common liquid chamber, the common liquid chamber as viewed in the first direction having a longitudinal direction defined as a second direction, and a transverse direction perpendicular to the second direction defined as a third direction,
the first channel substrate including a plurality of the first common liquid chambers arranged in the third direction therein, the first wall portion including a first partition wall that separates the plurality of the first common liquid chambers in the second direction,
the second channel substrate including a plurality of the second common liquid chambers arranged in the third direction therein, the second wall portion including a second partition wall that separates the plurality of the second common liquid chambers in the second direction,
the first common liquid chambers having an opening width in the third direction that is greater than an opening width in the third direction of the second common liquid chambers in a joint portion between the first common liquid chamber and the second common liquid chamber,
the second partition wall having a width in the third direction that is greater than a width in the third direction of the first partition wall in a joint portion between the first channel substrate and the second channel substrate.

16. The liquid ejection substrate according to claim 15,
wherein the second partition wall includes a part where the width in the third direction gradually decreases as the second partition wall extends away from the first channel substrate, the second partition wall having a minimum width in the third direction of at least 15 μm.

17. The liquid ejection substrate according to claim 1,
wherein the common liquid chamber has a length in the first direction of at least 600 μm.

18. The liquid ejection substrate according to claim 1,
wherein the first channel substrate and the second channel substrate are silicon-based substrates.

19. A liquid ejection head comprising:
a liquid ejection substrate having an internal liquid flow path including a nozzle, an individual channel communicating with the nozzle, and a common liquid chamber communicating with the individual channel, the liquid ejection substrate comprising:
a nozzle forming member having a liquid ejection surface on which the nozzle opens;
a first channel substrate including a first surface on which the nozzle forming member is provided, a second surface on an opposite side from the first surface, and a first wall portion forming a wall portion of the individual channel and the common liquid chamber;
a second channel substrate including a third surface joined to the second surface of the first channel substrate in a first direction and a second wall portion forming a wall portion of the common liquid chamber; and
a housing that supports the liquid ejection substrate,
wherein the second wall portion includes a part where a cross section perpendicular to the first direction has a different sectional area from a sectional area of the first wall portion.

20. A recording apparatus comprising:
a conveying portion configured to convey a recording medium;
a liquid ejection head configured to eject a liquid toward a recording medium being conveyed by the conveying portion, the liquid ejection head comprising:
a liquid ejection substrate having an internal liquid flow path including a nozzle, an individual channel communicating with the nozzle, and a common liquid chamber communicating with the individual channel, the liquid ejection substrate comprising:
a nozzle forming member having a liquid ejection surface on which the nozzle opens;
a first channel substrate including a first surface on which the nozzle forming member is provided, a second surface on an opposite side from the first surface, and a first wall portion forming a wall portion of the individual channel and the common liquid chamber;
a second channel substrate including a third surface that is joined to the second surface of the first channel substrate in a first direction and a second wall portion forming a wall portion of the common liquid chamber; and
a housing that supports the liquid ejection substrate,
wherein the second wall portion includes a part where a cross section perpendicular to the first direction has a different sectional area from a sectional area of the first wall portion.
